(19) United States
(12) Patent Application Publication
(10) Pub. No.: US 2026/0278788 A1
(43) Pub. Date: Sep. 17, 2026

(54) DIAGNOSIS OF DENTAL CONDITIONS FROM PATIENT IMAGES

(71) Applicant: Align Technology, Inc., San Jose, CA (US)

(72) Inventors: Yun Gao, Cary, NC (US); Guotu Li, Apex, NC (US); Christopher E. Cramer, Durham, NC (US); Chao Shi, Morrisville, NC (US); Elena Agilina, Holmdel, NJ (US)

(21) Appl. No.: 19/563,912

(22) Filed: Mar. 11, 2026

Related U.S. Application Data
(60) Provisional application No. 63/770,152, filed on Mar. 11, 2025.

(51) Int. Cl. G06T 7/00; G06T 7/11

(52) U.S. Cl. CPC G06T 7/0012; G06T 7/11; G06T 2207/30036; G06T 2207/30201

(57) ABSTRACT

Systems and methods for identifying a dental condition from a patient image are provided, including: accessing a 2D image depicting a patient's teeth; determining a segmentation mask for the 2D image, the segmentation mask including a plurality of tooth masks corresponding to a plurality of individual teeth of the patient's teeth; measuring at least one spatial parameter using the segmentation mask, where the at least one spatial parameter comprises one or more of a shape of an object feature in an intraoral cavity of the patient or a spatial relationship between two or more object features in the intraoral cavity of the patient; and identifying a dental condition for the patient's teeth based on the at least one spatial parameter.

### CROSS-REFERENCE TO RELATED APPLICATION(S)

The present application claims the benefit of priority to U.S. Provisional Application No. 63/770,152, filed Mar. 11, 2025, the disclosure of which is incorporated by reference herein in its entirety.

### TECHNICAL FIELD

The present technology generally relates to dentistry, and in particular, to diagnosis of dental conditions from patient images.

### BACKGROUND

Telemedicine systems can improve the convenience and accessibility of dental treatment by allowing clinicians to monitor the condition of a patient's teeth remotely. For instance, a clinician may evaluate the teeth and make treatment decisions based on photographs of the teeth, rather than requiring an in-person appointment to visually examine the teeth. Software algorithms may be used to automatically evaluate such photographs, but conventional algorithms have many drawbacks. For instance, many conventional software systems use machine learning models (e.g., neural networks) to identify and characterize features of interest in a photograph, but the accuracy and reliability of such models may be compromised by patient-to-patient variations in feature appearance, as well as the camera type, distance, and angle used to take the photograph. These problems may be exacerbated when using photographs that are taken by a layperson (e.g., the patient) rather than a dental practitioner. Moreover, if the feature of interest changes, the existing model may need to be re-trained for the new feature or a completely new model may need to be trained, which may be highly time-consuming and/or may require large amounts of new training data.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a block diagram illustrating a workflow for identifying a dental condition of a patient's teeth, in accordance with embodiments of the present technology.

FIG. 2A illustrates a representative example of a photograph of a patient's teeth, in accordance with embodiments of the present technology.

FIG. 2B illustrates a representative example of a 3D digital model of a patient's teeth, in accordance with embodiments of the present technology.

FIG. 3 illustrates a representative example of a 3D digital model for measurement of tooth crowding, in accordance with embodiments of the present technology.

FIG. 4 is a flow diagram illustrating a method for identifying a dental condition of a patient's teeth, in accordance with embodiments of the present technology.

FIG. 5 is a block diagram illustrating a workflow for identifying a dental condition of a patient's teeth, in accordance with embodiments of the present technology.

FIG. 6 is a block diagram illustrating a workflow for identifying a dental midline shift, in accordance with embodiments of the present technology.

FIGS. 7A-7D illustrate a representative example of determination of a dental midline shift from a patient photograph, in accordance with embodiments of the present technology.

FIGS. 8A-8C illustrate a representative example of identification of a facial midline from a patient photograph, in accordance with embodiments of the present technology.

FIG. 9 is a block diagram illustrating a workflow for identifying an uneven smile, in accordance with embodiments of the present technology.

FIGS. 10A-10C illustrate a representative example of determination of lip symmetry from a patient photograph, in accordance with embodiments of the present technology.

FIG. 11 illustrates a representative example of determination of incisor angulation from a patient photograph, in accordance with embodiments of the present technology.

FIG. 12 illustrates a representative example of a patient's teeth with an atypical gap due to a missing tooth, in accordance with embodiments of the present technology.

FIG. 13 is a block diagram illustrating a workflow for identifying an atypical gap and/or a missing tooth, in accordance with embodiments of the present technology.

FIGS. 14A and 14B illustrate a representative example of determination of an atypical gap from a patient photograph, in accordance with embodiments of the present technology.

FIG. 15 is a flow diagram illustrating a method for identifying a dental condition of a patient's teeth, in accordance with embodiments of the present technology.

FIG. 16A illustrates a representative example of a tooth repositioning appliance configured in accordance with embodiments of the present technology.

FIG. 16B illustrates a tooth repositioning system including a plurality of appliances, in accordance with embodiments of the present technology.

FIG. 16C illustrates a method of orthodontic treatment using a plurality of appliances, in accordance with embodiments of the present technology.

FIG. 17 illustrates a method for designing an orthodontic appliance, in accordance with embodiments of the present technology.

FIG. 18 illustrates a method for digitally planning an orthodontic treatment and/or design or fabrication of an appliance, in accordance with embodiments of the present technology.

### DETAILED DESCRIPTION

The present technology relates to systems and methods for diagnosing dental conditions from patient images. In some embodiments, for example, a method includes accessing a 2D image depicting a patient's teeth (e.g., a photograph or frame of a video). The method can include generating a 3D digital model of the patient's teeth, based partially or entirely on the 2D image (e.g., without using scan data and/or previously generated 3D digital models of the patient's teeth). The method can further include measuring at least one spatial parameter using the 3D digital model, where the at least one spatial parameter includes a geometry of an object feature in an intraoral cavity of the patient and/or a spatial relationship between two or more object features in the intraoral cavity of the patient. The method can continue with identifying a dental condition for the patient's teeth based on the at least one spatial parameter, such as tooth crowding, tooth spacing, overjet, overbite, underbite, crossbite, open bite, deep bite, narrow arch, tooth wear, abfraction, atypical tooth size (e.g., short clinical crowns), periodontitis, gum recession, dental midline shift, uneven smile, atypical gaps, and/or missing teeth.

As another example, in some embodiments, a method includes accessing a 2D image depicting a patient's teeth (e.g., a photograph or frame of a video). The method can include determining a segmentation mask for the 2D image, the segmentation mask including a plurality of tooth masks corresponding to a plurality of individual teeth of the patient's teeth. The method can further include measuring at least one spatial parameter using the segmentation mask, where the at least one spatial parameter includes a shape of an object feature in an intraoral cavity of the patient and/or a spatial relationship between two or more object features in the intraoral cavity of the patient. The method can continue with identifying a dental condition for the patient's teeth based on the at least one spatial parameter, such as tooth crowding, tooth spacing, overjet, overbite, underbite, crossbite, open bite, deep bite, narrow arch, tooth wear, abfraction, atypical tooth size (e.g., short clinical crowns), periodontitis, gum recession, dental midline shift, uneven smile, atypical gaps, and/or missing teeth.

The present technology can provide many advantages compared to conventional systems and methods for image-based diagnosis of dental conditions. For example, estimation of tooth crowding may be a significant consideration before starting orthodontic treatment, since the extent of crowding may affect treatment complexity. Many conventional methods for estimating tooth crowding from patient photographs use neural networks to predict crowding measurements. However, due to large variations in how patients take photographs (e.g., camera type, camera distance, camera angle, lighting conditions), even the same degree of crowding can have vastly different appearances in photographs, thus making it difficult for the neural network to produce accurate and consistent predictions. The same issue is present for many other types of measurements produced by neural networks and other machine learning models. Moreover, machine learning models are generally trained to predict a single specific measurement type; training of new models and/or re-training of existing models to predict a different measurement type can take significant time and require large amounts of training images.

To overcome these and other challenges, in some embodiments, the present technology provides systems and methods for estimating a 3D digital model of a patient's teeth from one or more 2D images of the teeth. The 3D digital model can be used to measure spatial parameters of interest to diagnose the patient with a dental condition. In some instances, the 3D digital model can be generated primarily or even entirely from the 2D image(s), without using scan data and/or a preexisting 3D digital model of the patient's teeth. Accordingly, rapid and accurate diagnoses may be made even for patients that are not readily available for an in-person appointment, such as new patients and fully remote patients. The use of a 3D digital model can improve flexibility and efficiency by allowing many different types of measurements and/or diagnoses to be performed using the same digital model, without lengthy training processes and/or large volumes of training data required for machine learning-based approaches.

Moreover, the 3D digital model can provide spatial information on the patient's dentition that may not be readily apparent from the 2D image(s). For instance, depending on the camera position and positioning of the patient's jaws, certain object features may be obscured or otherwise difficult to accurately visualize in the 2D image(s), e.g., the occlusal surfaces of teeth may be hidden if the patient takes a buccal photograph with their jaws closed. The 3D digital models described herein can estimate the 3D spatial parameters of such obscured features with a high degree of accuracy, thus providing 3D information on geometry, location, spatial relationships, etc., that would otherwise not be apparent through visual examination of the original 2D image(s). Moreover, the techniques herein can combine 2D information from multiple 2D images taken from different angles to reconstruct the 3D spatial parameters of an object of interest, where such 3D spatial parameters would be difficult or impossible to ascertain from visual examination of the 2D images only. Stated differently, the techniques for estimating the 3D spatial parameters from 2D images described herein could not be performed in the human mind (even with physical aids such as pen and paper), e.g., due to obscured, incomplete, and/or missing 3D spatial information in the 2D images.

Alternatively or in addition, in some embodiments, the present technology provides systems and methods for determining a segmentation mask from one or more 2D images of a patient's teeth, and then using the segmentation mask to measure spatial parameters of interest to diagnose the patient with a dental condition. The spatial parameters may be measured solely from the segmentation mask, without relying on scan data and/or 3D digital models of the patient's teeth. This approach can reduce the computational resources and processing time involved in evaluating the patient's teeth, thus allowing for rapid and accurate diagnoses on devices that may have less computing power (e.g., mobile devices such as smartphones).

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Systems and Methods for Identifying Dental Conditions

The present technology provides systems and methods for identifying a dental condition of a patient's teeth from one or more 2D images of the teeth, such as for purposes of remote monitoring and/or diagnosis, dental treatment planning (e.g., assessing the difficulty of the patient's case, determining the appropriate type and/or timing of treatment), etc. In some embodiments, the dental condition is identified by generating a digital representation of the teeth from the 2D image(s) (e.g., a 3D digital model and/or a 2D segmentation mask), using the digital representation to measure various spatial parameters of the teeth and/or other intraoral objects, and then determining which dental conditions may be present based on the measured spatial parameters.

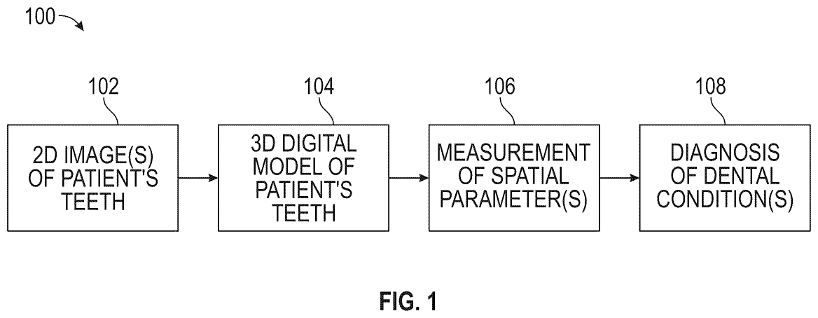

FIG. 1 is a block diagram illustrating a workflow 100 for identifying a dental condition of a patient's teeth, in accordance with embodiments of the present technology. In some embodiments, some or all of the processes described with respect to the workflow 100 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The workflow 100 can be utilized and/or combined with any of the other workflows and/or methods described herein.

The workflow 100 can include accessing one or more 2D images 102 including a depiction of a patient's teeth. Any suitable number of 2D images 102 can be used, such as a single 2D image 102 or a plurality of 2D images 102 (e.g., two, three, four, five, or more 2D images 102). The 2D images 102 can include any suitable image data type, such as one or more photographs (e.g., intraoral photographs, extraoral photographs), one or more frames of a video, etc. Each 2D image 102 can depict the patient from any suitable view, such as a front view of the patient's head while smiling, a close-up view of the patient's upper jaw, a close-up view of the patient's lower jaw, buccal views with the jaw open, buccal views with the jaw closed, occlusal views, lingual views, etc. The appropriate view may be determined based on the particular dental condition or treatment of interest, e.g., an upper occlusal view may be relevant for a patient who is undergoing or is being evaluated for palatal expansion therapy. In some situations, only some of the patient's teeth are depicted in the 2D image 102. For example, some of the patient's teeth may be covered by the patient's lips, other teeth, dental appliances, and/or other objects. Optionally, the 2D image 102 may include metadata indicating the image type, e.g., the dental view, whether dental appliances are present, etc.

The 2D images 102 can be obtained using any suitable imaging device, such as a digital camera (e.g., a DSLR camera, a mirrorless camera). Optionally, the imaging device can be part of or can be operably coupled to a computing device (e.g., a mobile device such as a smartphone or tablet; a desktop device; a server). The computing device may be operated by or associated with the patient, a healthcare provider (e.g., a clinician), or other suitable user. Alternatively or in combination, the 2D images 102 can be derived from scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data).

In some embodiments, the 2D images 102 are obtained using the imaging device only, without assistance from any auxiliary devices. In other embodiments, however, the 2D images 102 can be obtained using the imaging device in combination with an auxiliary device to position the imaging device in a fixed spatial location with respect to the patient's teeth and/or to retract the patient's cheeks and lips to improve visibility of the teeth. For example, the auxiliary device can include one or more cheek retractors. As another example, the auxiliary device can be a tube-type device including a smartphone interface configured to couple to a smartphone (or other mobile device with a camera), a patient interface configured to retract the patient's cheeks and lips, and a tubular body between the smartphone interface and the patient interface with a lumen extending therethrough, e.g., as described in U.S. Patent Application Publication No. 2022/0338723, the disclosure of which is incorporated by reference herein in its entirety. Other representative examples of systems, methods, and devices for obtaining 2D images of a patient are provided in U.S. Patent Application Publication No. 2022/0023003.

In some embodiments, the obtained images may be transmitted to a remote server or some other computing system (e.g., on a local network) for performing some or all of the subsequent steps. In some embodiments, the 2D images 102 are accessed from a database, such as an image repository. The image repository can be part of a local computing system, such as a dental treatment system. Optionally, the 2D images 102 may be stored on a mobile device, such as a smartphone. Alternatively or additionally, the 2D images 102 may be stored on a remote server.

In some embodiments, the 2D images 102 depict one or more object features within or proximate to the patient's intraoral cavity, such as a tooth, a gum, a lip, a facial midline, a dental auxiliary (e.g., an attachment mounted on a tooth), a dental appliance (e.g., an aligner, a palatal expander, a retainer), etc. The object features may be relevant for diagnosis of a dental condition. However, some of the object features may be partially or entirely obscured in the 2D image 102, e.g., depending on the viewpoint of the 2D image 102 and/or the positioning of the patient's jaws. Moreover, because the 2D image 102 provides a 2D representation of the intraoral cavity, 3D spatial information of object features may be difficult to ascertain, e.g., it may be challenging or impossible to accurately measure 3D sizes, shapes, distances, etc. Stated differently, if the 2D image 102 depicts an X-Y plane, it may be challenging or impossible to accurately measure spatial information that has a significant Z-component (e.g., measuring distance in a direction that is not contained entirely within the X-Y plane).

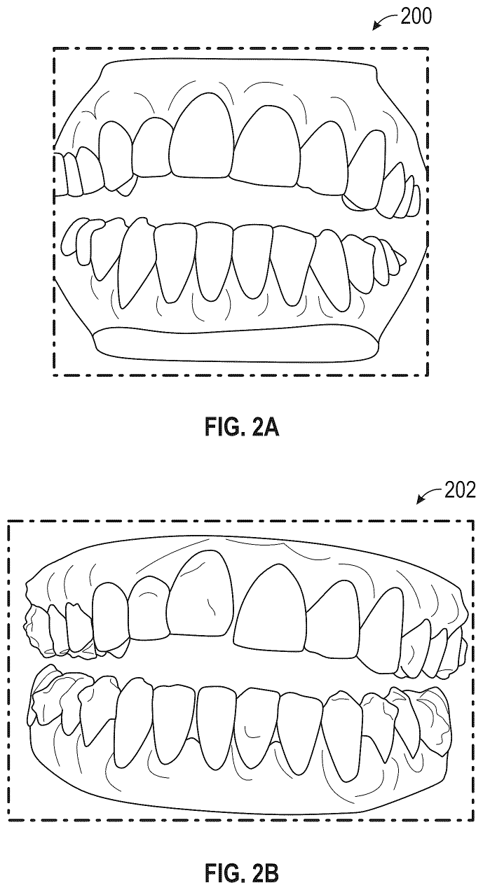

For example, FIG. 2A illustrates a representative example of a photograph 200 of a patient's teeth, in accordance with embodiments of the present technology. The photograph 200 is taken from a frontal view with an open bite and shows the buccal surfaces of the anterior teeth. However, other features of the teeth are obscured, such as the lingual and occlusal surfaces of the teeth, as well as the posterior teeth. Accordingly, it may be difficult or impossible to accurately ascertain features such as arch length (which is typically measured along the occlusal surfaces of the arch), inter-molar arch width, etc.

Referring again to FIG. 1, to allow for measurement of 3D spatial information, the workflow 100 can generate a 3D digital model 104 of the patient's teeth, based on the one or more 2D images 102. The 3D digital model 104 can be a surface model, solid model, shell model, parametric model, or any other digital representation depicting the 3D characteristics (e.g., size, shape, location, spatial relationships) of the teeth and/or other object features of interest. The 3D digital model 104 may depict one or both of jaws of the patient, and may depict some or all of the patient's teeth.

The 3D digital model 104 can be generated using various techniques. For example, the 3D digital model 104 can be built from a generic 3D digital model that depicts teeth with generic parameters (e.g., generic size, shape, and/or locations in the arch). The generic 3D digital model may be produced from historical patient data (e.g., 3D digital models of teeth of a plurality of actual patients) and/or simulated patient data (e.g., 3D digital models of teeth of a plurality of simulated patients, such as patients with teeth in “ideal” positions). The generic parameters for the generic 3D digital model may be obtained by averaging or otherwise combining the parameters from the historical and/or simulated patient data, e.g., an average size, shape, and/or location can be determined for each tooth in the generic 3D digital model.

The 3D digital model 104 can then be produced by determining patient-specific parameters for the particular patient, and then adjusting one or more teeth of the generic 3D digital model according to the patient-specific parameters, thereby producing a patient-specific digital model (the 3D digital model 104). The patient-specific parameters may be determined based on the 2D images 102. For instance, one or more registrations may be performed between the generic 3D digital model and one or more of the 2D images 102, where each registration involves varying the values of one or more generic parameters of the generic 3D digital model and/or one or more camera parameters (e.g., camera pose), generating a 2D projection of the generic 3D digital model with the varied parameters, and then comparing the 2D projection to the 2D image 102. This process can be performed iteratively until a satisfactory registration is achieved, e.g., the 2D projection is sufficiently similar to the 2D image 102. The values for the generic parameters that produced the satisfactory registration can be used as the patient-specific parameters. These patient-specific parameters can then be applied to the teeth of the generic 3D digital model (e.g., to adjust the size, shape, and/or location of each tooth from an average size, shape, and/or location to a patient-specific size, shape, and/or location), thereby producing the 3D digital model 104.

Additional details of techniques that may be used to generate the 3D digital model 104 from one or more 2D images 102 are provided in U.S. Pat. Nos. 11,666,416, 11,723,748, the disclosures of each of which are incorporated by reference herein in their entirety.

In some embodiments, the 3D digital model 104 is generated primarily or even solely using the 2D images 102. For instance, the 3D digital model 104 may be generated without using scan data of the patient's teeth and/or without using a previously generated 3D digital model of the patient's teeth. In some embodiments, the techniques herein allow for rapid generation of patient-specific 3D digital models, e.g., the 3D digital model 104 may be generated in less than 2 minutes, 1 minutes, 45 seconds, or 30 seconds.

In some embodiments, the 3D digital model 104 depicts one or more object features within the patient's intraoral cavity, such as a tooth, a gum, a lip, a facial midline (or other anatomical reference line), a dental auxiliary (e.g., an attachment mounted on a tooth), a dental appliance (e.g., an aligner, a palatal expander, a retainer), etc. The 3D digital model 104 may depict one or more object features that were obscured in the 2D image 102, e.g., the 3D digital model 104 may provide spatial information of an obscured object feature (e.g., size, shape, location), where such spatial information was not visually apparent or otherwise not capable of being accurately measured from the 2D image 102 alone. For instance, object features that were represented only in two dimensions (e.g., X and Y) in the 2D image 102 may now be represented in three dimensions in the 3D digital model 104 (e.g., X, Y, and Z).

In some embodiments, the 3D digital model 104 is generated from a plurality of 2D images 102 depicting different views of the teeth (e.g., a first 2D image 102 depicting a first view, a second 2D image 102 depicting a second, different view, etc.). The different views can be used to reconstruct and/or estimate the 3D geometry of object features depicted in the different views, thereby providing 3D spatial information of the object features that could not be ascertained by visual examination of the 2D images 102 on their own. For instance, the 3D shape of features such as the size and/or shape of abfractions, gingiva, tooth roots, tooth wear, etc., may not be apparent from individual 2D views of such features, but may be more accurately evaluated from a 3D digital model of such features.

For example, FIG. 2B illustrates a representative example of a 3D digital model 202 of a patient's teeth, in accordance with embodiments of the present technology. The 3D digital model 202 may be generated based on the photograph 200 of FIG. 2A. As shown in FIG. 2B, the 3D digital model 202 includes digital models of teeth of both jaws, including both the anterior teeth (which were visible in the photograph 200) as well as the posterior teeth (which were obscured in the photograph 200). The digital models of the teeth can depict all external surfaces of the teeth, including the buccal surfaces (which were visible in the photograph 200) and the lingual and occlusal surfaces (which were obscured in the photograph 200).

Referring again to FIG. 1, the 3D digital model 104 can be used to measure one or more spatial parameters 106 of one or more object features in the patient's intraoral cavity. As discussed herein, the object features can include a tooth, a gum, a lip, a facial midline (or other anatomical reference line), a dental auxiliary, a dental appliance, or a combination thereof. For instance, the spatial parameters 106 can include a shape of an object feature, a size of an object feature, a distance of an object feature with respect to another object feature, or an angle of an object feature with respect to another object feature. In some embodiments, a plurality of different spatial parameters 106 are measured using the same 3D digital model 104, such as two, three, four, five, 10, 20, 50, or more different spatial parameters 106.

In some embodiments, the spatial parameters 106 includes a geometry of an object feature, such as the size and/or shape of a tooth (or a portion thereof), the size and/or shape of the gingival margin adjacent to a tooth, etc. Examples of spatial parameters 106 corresponding to the geometry of an object feature can include any of the following: the size of a tooth (e.g., tooth height (e.g., clinical crown height), tooth width (e.g., mesiodistal or buccolingual width)), the shape of a tooth, the size of a portion of a tooth (e.g., abfractions, cusps, exposed roots), the shape of a portion of a tooth, the size of the gingiva (e.g., amount of gingival overgrowth, degree of puffiness), the shape of the gingiva, etc.

In some embodiments, the spatial parameters 106 include a spatial relationship between two or more object features, such as two or more teeth (two teeth of the same jaw, a tooth in the upper jaw and the tooth in the lower jaw), a tooth and an anatomical reference line (e.g., a dental midline or a facial midline), etc. The spatial relationship can be a distance between the object features (e.g., a straight-line distance or a distance measured along the mesial-distal axis of the arch), an angle of one object feature relative to another object feature, etc. Examples of spatial parameters 106 corresponding to spatial relationships between object features include: arch length, arch width (e.g., intercanine arch width, intercanine arch length), interproximal spacing, distance from the dental midline and/or facial midline, overbite distance, overjet distance, underbite distance, open bite distance, deep bite distance, crossbite distance, etc.

As described herein, the 3D digital model 104 may depict object features that were obscured in the 2D image 102, thus allowing one or more spatial parameters 106 to be measured with respect to the obscured object features. For example, if the 2D image 102 depicted a buccal view of the patient's teeth, the 3D digital model 104 may allow for measurement of a spatial parameter 106 with respect to occlusal and/or lingual surfaces of the teeth. As another example, if the 2D image 102 depicted an anterior view of the teeth, the 3D digital model 104 may allow for measurement of a spatial parameter 106 with respect to one or more posterior teeth. In this example, essentially, the teeth arrangement of the anterior teeth as depicted in the 2D image 102 is being used to determine hidden information about the posterior teeth using the methods described herein for estimating a 3D digital model 104 of the entire jaw. Thus, once the 3D digital model 104 is generated, the 3D digital model 104 would provide a likely teeth arrangement of the posterior teeth as well, and this information can then be used to, for example, measure likely arch lengths, measure likely distances between teeth including the posterior teeth, assess likely crowding including the posterior teeth, and/or discover potential malocclusions including the posterior teeth. Thus, the methods and systems herein allow for access to unknown or hidden information, and determination of issues and/or conditions of the patient that can be used for treating the patient. In a further example, a 3D digital model 104 can be generated from a series of 2D images 102 depicting different 2D views of an object feature, and the spatial parameter 106 can be measured with respect to a 3D shape and/or size of the object feature.

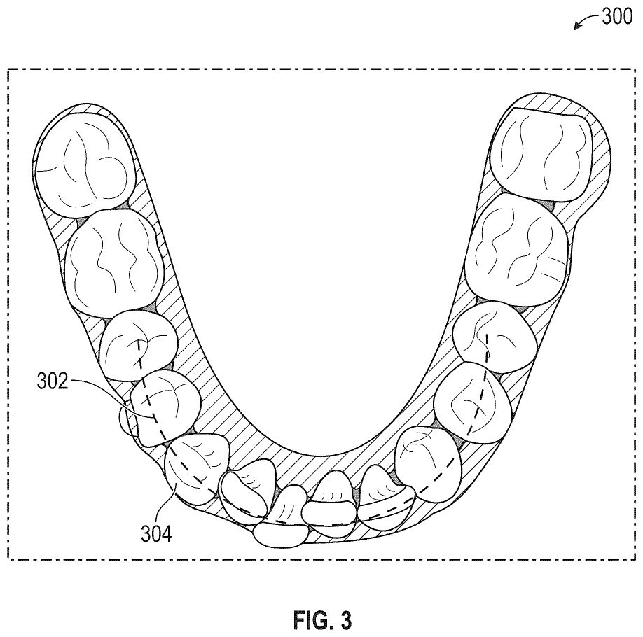

For example, FIG. 3 illustrates a representative example of a 3D digital model 300 for measurement of tooth crowding, in accordance with embodiments of the present technology. In some situations, it may be difficult to estimate tooth crowding from a 2D image due to variability in how the photographs are taken by the user. Moreover, due to the U shape of the arch, the amount of tooth crowding can be difficult to see from certain viewpoints. Clinicians typically use an occlusal view to measure tooth crowding, but photographs taken by laypersons (e.g., using a smartphone or other camera device) typically depict a buccal or anterior view (e.g., similar to the photograph 200 of FIG. 2A) since occlusal photographs can be difficult to take.

The 3D digital model 300 can be generated from one or more 2D images as discussed above, and then used to determine the amount of tooth crowding. In some embodiments, once the 3D digital model 300 is generated, as shown in FIG. 3, an arch length 302 (e.g., from the left canine to the right canine) is measured along an occlusal plane corresponding to the occlusal surfaces of the teeth in the 3D digital model 300. The arch length 302 can be measured by: finding two end points on the occlusal surface of the teeth that lie along a tangent of the jaw arch, projecting one or more points of the 3D digital model 300 corresponding to the teeth onto the occlusal plane, fitting a spline curve to the points (estimated jaw arch), and measuring the canine-to-canine arch length 302. The mesiodistal width of each tooth 304 along the arch length 302 can be measured. The mesiodistal width refers to the measurement of the width of a tooth from the mesial surface to the distal surface along the dental arch. It essentially captures the horizontal length of each tooth as they are arranged side by side in the jaw. The amount of tooth crowding can then be calculated by summing the mesiodistal widths across the teeth 304 and then comparing the sum to the arch length 302 (which may involve, e.g., subtracting the arch length 302 from the sum). For example, if the sum of the mesiodistal widths exceeds the arch length 302, it indicates that the teeth are crowded, as there may be insufficient space to accommodate the teeth properly within the dental arch. This discrepancy between the total tooth widths and the arch length 302 is used to quantify the degree of crowding, which can then be addressed through various orthodontic treatments. In some embodiments, an amount of crowding may be determined for a subregion of the jaw.

Crowding in this subregion may be determined by summing the mesiodistal widths of subset of the teeth 304 corresponding to the subregion, and then comparing this sum to an arch length of a portion of the arch corresponding to the subregion (which may involve, e.g., subtracting this arch length from this sum).

Referring again to FIG. 1, the measured spatial parameters 106 can be used to diagnose the patient with one or more dental conditions 108, such as tooth crowding, tooth spacing, overjet, overbite, underbite, crossbite, open bite, deep bite, narrow arch, tooth wear, abfraction, atypical tooth size (e.g., short clinical crowns), periodontitis, gum recession, dental midline shift, uneven smile, atypical gaps, and/or missing teeth. For instance, tooth crowding can be diagnosed based on arch length for one or more teeth and a tooth width for each of the one or more teeth. As another example, a narrow arch can be diagnosed based on an arch width. In another example, conditions related to jaw relationships such as overjet, overbite, underbite, crossbite, open bite, deep bite, etc., can be measured based on the corresponding spatial relationships between teeth of the upper and lower jaws. By generating estimated 3D models of both jaws and estimating their relationship to each other (e.g., based on the dimensions of the arches), the articulation and/or occlusion of the jaws can be estimated (e.g., to determine overjet, overbite, underbite, crossbite, open bite, deep bite, etc.). In a further example, tooth wear can be diagnosed based on the shapes of the crowns of one or more teeth. In yet another example, abfractions can be diagnosed based on the size and/or shape of grooves at the gingival portions of one or more teeth. These abfractions may be difficult to identify in a 2D image, but may become more visible in a 3D model (e.g., which may allow a user to view the abfraction from different views). As a further example, conditions related to the gingiva (e.g., periodontitis, gum recession) may be diagnosed based on size and/or shape of the gingival margin, and/or the size and/or shape of the portions of the teeth adjacent to the gingival margin.

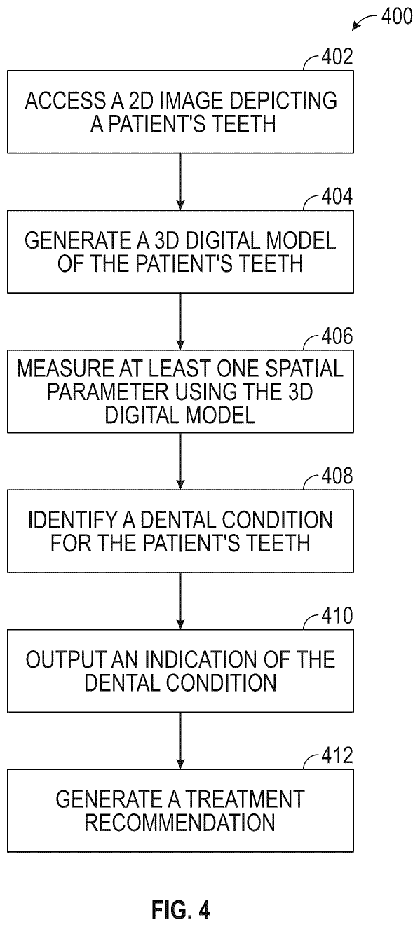

FIG. 4 is a flow diagram illustrating a method 400 for identifying a dental condition of a patient's teeth, in accordance with embodiments of the present technology. In some embodiments, some or all of the processes of the method 400 are implemented as computer-readable instructions (e.g., program code) that are configured to be executed by one or more processors of a computing device (e.g., a mobile device, laptop, personal computer, workstation, remote server). In some embodiments, the computing device is part of a virtual dental care system as described in, e.g., U.S. Patent Application Publication No. 2022/0023003. The method 400 can be utilized and/or combined with any of the other workflows and/or methods described herein, such as the workflow 100 of FIG. 1.

The method 400 can begin at block 402 with accessing at least one 2D image depicting a patient's teeth, e.g., as discussed above with respect to the 2D images 102 of FIG. 1. For example, the 2D image can be a photograph or frame of a video obtained using an imaging device (e.g., a camera of a mobile device). The 2D image can depict the patient's teeth and/or other object features in the intraoral cavity from a particular view. Optionally, a plurality of 2D images depicting the patient's teeth from a plurality of different views can be obtained.

At block 404, the method 400 can include generating a 3D digital model of the patient's teeth, e.g., as discussed above with respect to the 3D digital model 104 of FIG. 1. The 3D digital model may be generated based primarily or solely based on the 2D image, and optionally, without using scan data and/or previously generated 3D digital models of the patient's teeth. In some embodiments, the 3D digital model is built from a generic 3D digital model of generic teeth, such as by iteratively varying the parameters of the generic teeth until the generic 3D digital model can be successfully registered to the 2D model.

The 3D digital model can provide 3D spatial information for one or more object features that are obscured or otherwise difficult to accurately characterize in the 2D image. In some embodiments, the 3D digital model is generated based on a plurality of 2D images depicting a plurality of different views of the teeth, where the different views are used to reconstruct and/or estimate the 3D geometry of object features depicted in the different views.

At block 406, the method 400 can include measuring at least one spatial parameter using the 3D digital model, e.g., as discussed above with respect to the spatial parameters 106 of FIG. 1. For instance, the spatial parameter can include a geometry of an object feature of the intraoral cavity and/or a spatial relationship between two or more object features of the intraoral cavity. The object features can include a tooth, a gum, a lip, a facial midline (or other anatomical reference line), a dental auxiliary, a dental appliance, or a combination thereof. In some embodiments, the spatial parameters include a shape of an object feature, a size of an object feature, a distance of an object feature with respect to another object feature, or an angle of an object feature with respect to another object feature. Some or all of the object features used in the measurement of the spatial parameter may be object features that were obscured in the 2D image, as discussed above.

At block 408, the method 400 can continue with identifying a dental condition for the patient's teeth, based on the at least one spatial parameter. Examples of dental conditions that may be identified include tooth crowding (e.g., as discussed with respect to FIG. 3), tooth spacing, overjet, overbite, underbite, crossbite, open bite, deep bite, narrow arch, tooth wear, abfraction, atypical tooth size (e.g., short clinical crowns), periodontitis, gum recession, dental midline shift, uneven smile, atypical gaps, and/or missing teeth. The dental condition may be identified based on the value of the spatial parameter (e.g., by comparing the value of the spatial parameter to a threshold value associated with the dental condition), based on the values of two or more spatial parameters (e.g., by comparing the values to each other; by summing, subtracting, multiplying, dividing, or otherwise combining the values via any suitable mathematical operation), based on statistics calculated from the values of two or more spatial parameters (e.g., averages, medians, standard deviations), or suitable combinations thereof. In some embodiments, spatial parameters calculated from a single 3D digital model are used to evaluate the patient for a plurality of different dental conditions, such as two, three, four, five, or more different dental conditions.

At block 410, the method 400 can include outputting an indication of the dental condition via a display. For instance, the indication can be displayed on a monitor or screen that is associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a dental monitoring service provider) via a communications network. In some embodiments, the computing device used to display the indication of the dental condition is the same as the computing device used to perform the other processes of the method 400, e.g., all of the processes of the method 400 are performed by a local client device. In other embodiments, the computing device used to display the indication of the dental condition is different than the computing device used to perform the other processes of the method 400, e.g., the indication of the dental condition is displayed by a local client device and the other processes are performed by a remote server.

The indication of the dental condition can be provided in any suitable format, such as textually, numerically, graphically, etc. For instance, the indication of the dental condition can be an overlay or other graphical element that is displayed together with the 2D image. The indication may be displayed at a location in the 2D image corresponding to the location of the identified dental condition, e.g., using labels, graphics, coloring, shading, etc. In some embodiments, a user may be alerted to dental conditions such as tooth wear, abfraction, periodontitis, gum recession, etc., via graphical elements at the corresponding locations on the teeth and/or gingiva in the 2D image. In some embodiments, a user may be alerted to dental conditions such as tooth crowding, tooth spacing, overjet, overbite, underbite, crossbite, open bite, deep bite, narrow arch, atypical gaps, missing teeth, etc., via displayed information representing the magnitude and/or severity of the dental condition (e.g., the value of the measured spatial parameter, a comparison of the value of the measured spatial parameter to a threshold value indicative of a dental condition, a qualitative rating of severity).

At block 412, the method 400 can include generating a treatment recommendation, based on the dental condition. The treatment recommendation can be output to a user, e.g., via the same display used for the indication of the dental condition. The treatment recommendation can include a recommended action for addressing the dental condition, such as any of the following: a recommendation that the patient come in for an in-person appointment (e.g., for visual examination by a clinician, for additional imaging), a recommendation that the patient take additional 2D images for further analysis, a recommendation of a particular treatment type (e.g., dental appliances for an orthodontic treatment, improved oral hygiene practices, surgical interventions), a recommendation of a particular treatment timing (e.g., treatment is needed immediately, treatment is not needed immediately but continued monitoring is recommended), etc.

Alternatively or in combination, the treatment recommendation can include a recommended action with respect to a planned dental treatment for the patient in view of the patient's dental condition. For instance, certain dental conditions may make it more difficult to treat a particular patient with dental appliances, such that alternative treatments may be indicated (e.g., surgical intervention, treatment with different appliance types) and/or dental appliance treatment may be delayed until the patient's dental condition has changed. Accordingly, the identified dental condition may be used to determine a case difficulty assessment (e.g., which may be a quantitative or qualitative measurement) that informs the clinician whether the patient is a good candidate for dental appliance treatment (e.g., orthodontic treatment) and/or other treatment types. In some embodiments, the treatment recommendation includes one or more of the following: a recommendation that the patient's teeth are ready for treatment, a recommendation that treatment should be delayed, a recommendation of a type of treatment for the patient's teeth, or a recommendation that the patient's teeth are not suitable for a type of treatment. For example, if the patient has short crowns, it may be beneficial to wait until the teeth have erupted further. As another example, if the patient has a narrow arch, it may be beneficial to widen the arch (e.g., via palatal expansion) before applying other treatments to the teeth. If the treatment recommendation involves delaying treatment, such a recommendation may be provided in combination with a prediction of when the patient's teeth are likely to be ready for treatment.

In some embodiments, the treatment recommendation may indicate a treatment metric, such as the estimated length of treatment based on one or more measured spatial parameters. For example, one or more 2D images of a patient's teeth may be used to assess a case difficulty, and/or may be used to estimate a treatment plan (e.g., estimating treatment stages required to move the teeth to a final tooth arrangement). An estimated length of orthodontic treatment may then be determined based on the assessed case difficulty and/or on the estimated treatment plan. Alternatively or additionally, an estimated number of dental appliances (e.g., aligners, palatal expanders) may be determined in line with the estimated treatment plan. Alternatively or additionally, a cost of treatment may be estimated. One or more of these determinations may be provided to the patient and/or doctor (e.g., on a display device) as described previously.

The method 400 illustrated in FIG. 4 can be modified in many different ways. For example, although the above processes of the method 400 are described with respect to a single 2D image, the method 400 can be applied sequentially or concurrently to any suitable number of images. As another example, the ordering of the processes shown in FIG. 4 can be varied, or some processes may be performed concurrently. In some embodiments, the method 400 may be performed on a remote server (e.g., a server computing device). For example, a patient or doctor device (e.g., a smartphone) may be used to capture a 2D image, and this 2D image may be transmitted to the remote server (e.g., via a smartphone application). The remote server may then execute any of the processes of blocks 404-412. In other embodiments, the method 400 may be entirely performed on a local client device (e.g., a mobile device, a personal computer). In some embodiments, some of the steps may be performed on a remote server, and some of the steps may be performed on a local client device. Some of the processes of the method 400 can be omitted (e.g., the process of block 410 and/or block 412) and/or the method 400 can include additional processes not shown in FIG. 4 (e.g., administering a treatment to the patient according to the treatment recommendation of block 412).

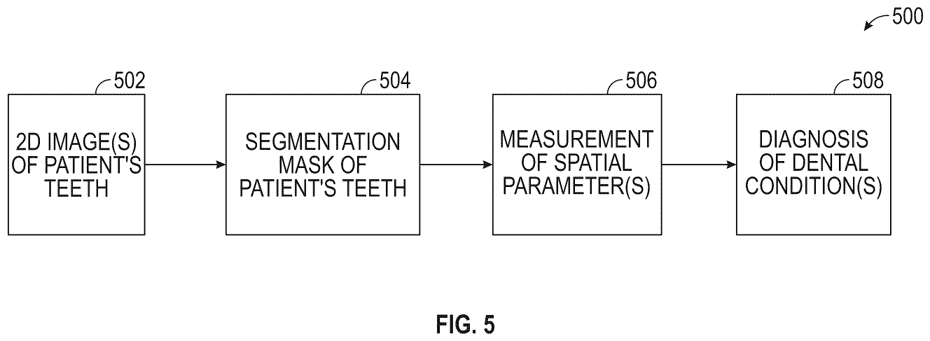

FIG. 5 is a block diagram illustrating a workflow 500 for identifying a dental condition of a patient's teeth, in accordance with embodiments of the present technology. In some embodiments, some or all of the processes described with respect to the workflow 500 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 500 can be utilized and/or combined with any of the other workflows and/or methods described herein (e.g., the workflow 100 of FIG. 1 and/or the method 400 of FIG. 4).

The workflow 500 can include accessing one or more 2D images 502 including a depiction of a patient's teeth. This process may be identical or generally similar to the process described with respect to the 2D images 102 of the workflow 100 of FIG. 1, and the 2D images 502 can be identical or generally similar to the 2D images 102 of FIG. 1.

The workflow 500 can generate a segmentation mask 504 of the patient's teeth, based on the one or more 2D images 502. The segmentation mask 504 can include a plurality of tooth masks corresponding to a plurality of individual teeth of the patient and, optionally, a plurality of tooth identifiers for the tooth masks. For instance, the tooth masks can be geometric elements (e.g., lines, contours, areas) representing the boundaries, shapes, and/or sizes of individual teeth, and the tooth identifiers can indicate the identity of each tooth mask (e.g., based on the universal numbering system or any other suitable dental notation scheme). In some embodiments, the segmentation mask 504 is provided as a 2D digital representation (e.g., a 2D image) including the determined tooth masks, which may be represented as a series of contour lines representing tooth boundaries for the individual teeth, areas representing tooth geometries for each tooth (such as the regions enclosed by the contour lines), etc. The segmentation mask 504 can further include the tooth identifiers for each tooth, which may be incorporated into the 2D digital representation itself (e.g., as pixel values, labels, symbols) or may be metadata associated with 2D digital representation. Optionally, the segmentation mask 504 can include geometric elements (e.g., points, lines, contours, areas) corresponding to the boundaries, shapes, and/or sizes of other object features of the intraoral cavity, such as the lips, gingiva, etc.

The segmentation mask 504 may be generated from the 2D images 502 using any suitable technique, such as automatically via a segmentation algorithm (e.g., semantic segmentation algorithm, object instance segmentation algorithm, panoptic segmentation algorithm). Examples of segmentation algorithms are described in U.S. Patent Application Publication Nos. 2022/0023003 and 2023/0225831, the disclosures of which are incorporated by reference herein in their entirety.

The segmentation mask 504 can be used to measure one or more spatial parameters 506 of one or more object features in the patient's intraoral cavity. The object features can include a tooth, a gum, a lip, a facial midline (or other anatomical reference line), a dental auxiliary, a dental appliance, or a combination thereof. For instance, the spatial parameters 506 can include a shape of an object feature, a size of an object feature, a distance of an object feature with respect to another object feature, or an angle of an object feature with respect to another object feature. In some embodiments, the spatial parameters 506 includes a geometry of an object feature, such as the size and/or shape of a tooth (or a portion thereof), the size and/or shape of the gingival margin adjacent to a tooth, the size and/or shape of the patient's lips and/or mouth opening, etc. In some embodiments, the spatial parameters 506 include a spatial relationship between two or more object features, such as two or more teeth (two teeth of the same jaw, a tooth in the upper jaw and the tooth in the lower jaw), a tooth and an anatomical reference line (e.g., a facial midline or dental midline), etc. The spatial relationship can be a distance between the object features (e.g., a straight-line distance or a distance measured along the mesial-distal axis of the arch), an angle of one object feature relative to another object feature, etc.

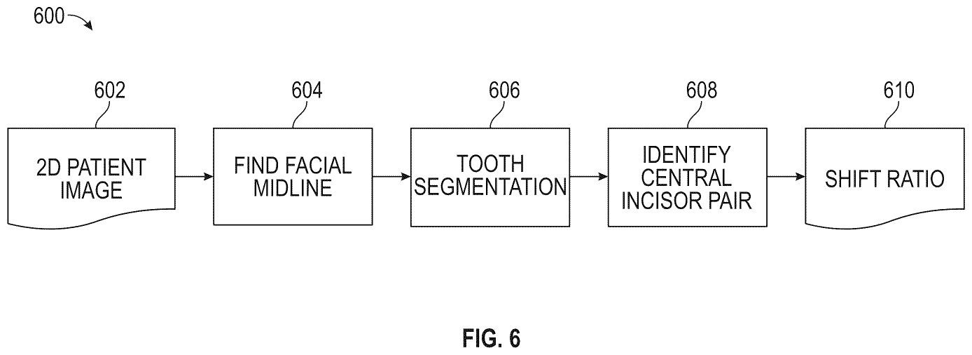

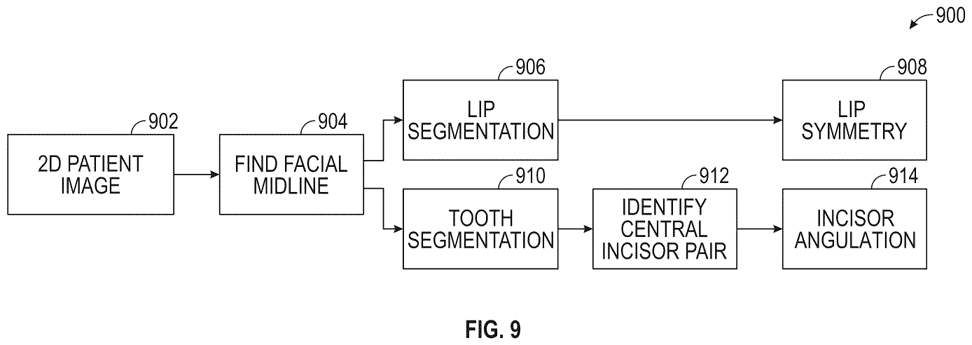

The measured spatial parameters 506 can be used to diagnose the patient with one or more dental conditions 508, such as dental midline shift, uneven smile, tooth crowding, tooth spacing, overjet, overbite, underbite, crossbite, open bite, deep bite, narrow arch, tooth wear, abfraction, atypical tooth size (e.g., short clinical crowns), periodontitis, gum recession, atypical gaps, and/or missing teeth. For instance, a dental midline shift (e.g., the dental midline of the teeth is misaligned with the facial midline) can be determined based on a central incisor shift ratio that characterizes the discrepancy between the dental midline and the patient's facial midline, e.g., as discussed below with respect to FIGS. 6-8D. As another example, an uneven smile (e.g., the teeth and/or lips are asymmetrical about the facial midline) can be determined based on lip symmetry and/or central incisor angulation, e.g., as discussed below with respect to FIGS. 9-11. In a further example, an atypical gap (e.g., a gap between two neighboring teeth that is larger than ideal from an aesthetic standpoint or that is otherwise undesirable) and/or missing teeth can be determined based on a tooth distance to tooth width ratio, e.g., as discussed below with respect to FIGS. 12-14B.

FIG. 6 is a block diagram illustrating a workflow 600 for identifying a dental midline shift, in accordance with embodiments of the present technology. In some embodiments, some or all of the processes described with respect to the workflow 600 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 600 can be utilized and/or combined with any of the other workflows and/or methods described herein (e.g., the workflow 100 of FIG. 1, the method 400 of FIG. 4, and/or the workflow 500 of FIG. 5).

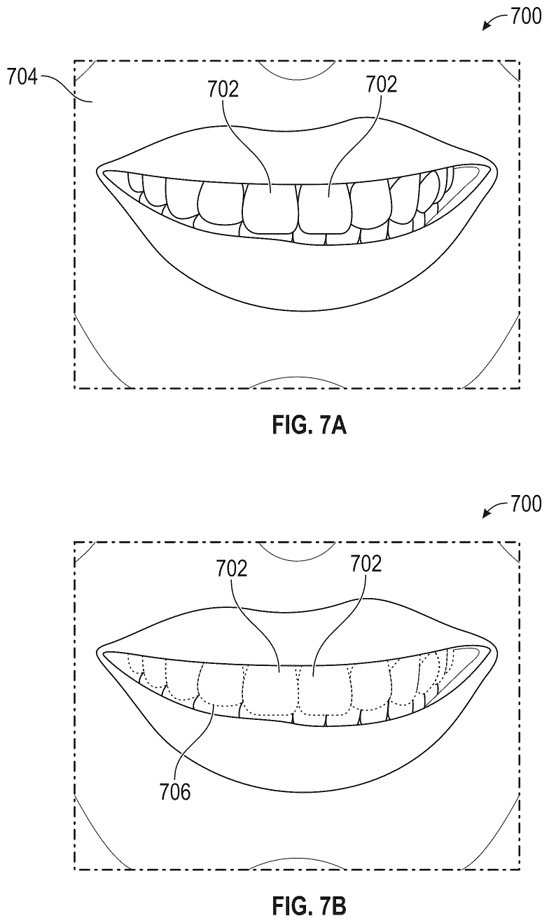

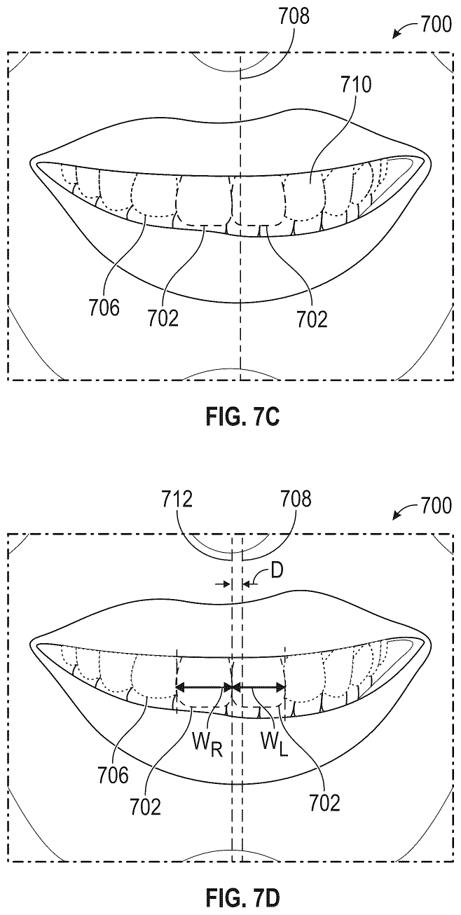

The workflow 600 can include accessing a 2D image of the patient, such as an anterior, full-face, and/or open mouth photograph (block 602). For example, FIG. 7A is a representative example of a photograph 700 of a patient's teeth that may be used in the workflow 600, in accordance with embodiments of the present technology. In the photograph 700, the anterior teeth of the patient's upper jaw, including the upper central incisors 702, are visible. The photograph 700 may also depict some or all of the patient's face (e.g., lips, nose, eyes, eyebrows, cheeks, chin, temples, ears).

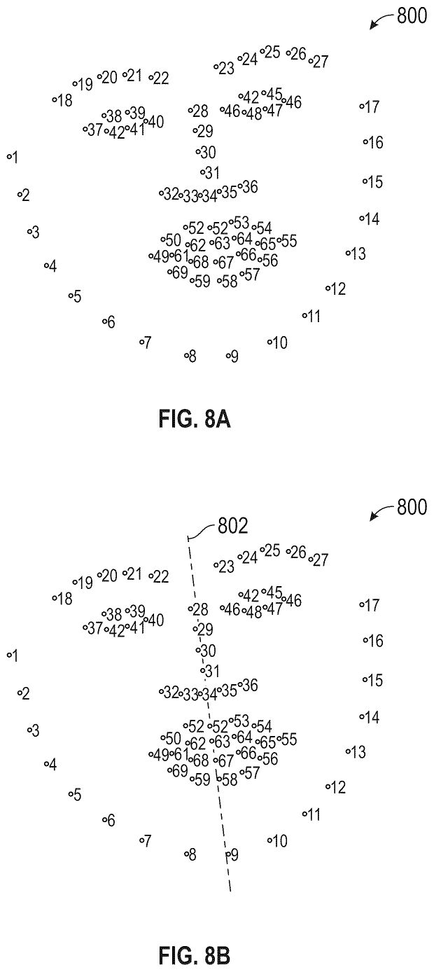

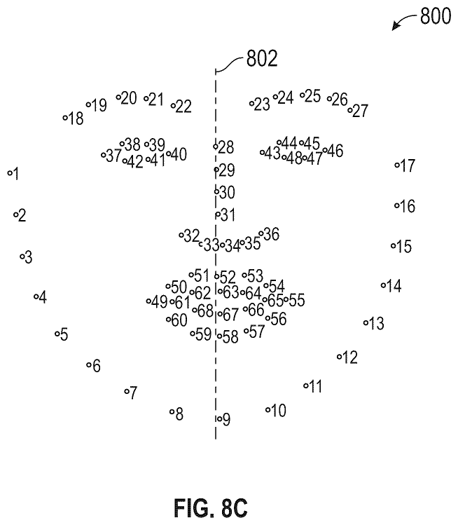

Referring again to FIG. 6, the workflow 600 can include finding a facial midline of the patient in the 2D image (block 604). The facial midline can be determined from the patient photograph in various ways, such as calculated based on one or more facial landmarks. For example, FIG. 8A is a representative example of facial landmarks that may be used in the workflow 600, in accordance with embodiments of the present technology. The facial landmarks can include any of the following: facial outline landmarks (numbered 1-17 in FIG. 8A) corresponding to the outline of the patient's face (e.g., chin and jawline), eyebrow landmarks (numbered 18-27) corresponding to the upper edge of the patient's eyebrows, nasal landmarks (numbered 28-36) corresponding to the features of the patient's nose (e.g., nasal centerline, subnasion), eye landmarks corresponding to the features of the patient's eyes (numbered 37-48) (e.g., corners, lids), and/or mouth landmarks corresponding to the features of the patient's mouth (numbered 49-68) (e.g., lips, mouth opening, teeth, gingiva). Facial landmarks may be identified from a patient photograph using a software algorithm utilizing suitable computer vision and/or machine learning techniques (e.g., convolutional neural networks and/or other deep learning techniques). The input to the algorithm can be a patient image, and the output of the algorithm can be the locations (e.g., X- and Y-coordinates) of each facial landmark in the patient image. For example, the facial landmark detector algorithm can use an ensemble of regression trees that have been trained on a plurality of manually annotated patient images to estimate the locations of facial landmarks from a sparse subset of pixel intensities.

Referring next to FIG. 8B, a facial midline 802 can be determined from the facial landmarks 800. For example, the locations of facial landmarks that are expected to be at or near the center of the patient's face (e.g., nose/subnasion landmarks) can be directly used as points on the facial midline 802. Alternatively or in combination, the locations of facial landmarks that are expected to be vertically symmetric about the facial midline 802 can be used to calculate midpoints, and the midpoints can be used as points on the facial midline 802. In some embodiments, the facial midline 802 is calculated by determining a plurality of midline sections from respective sets of facial landmarks, then averaging the midline sections. For example, an upper midline section can be calculated based on landmarks at or near the eyes, a lower midline section can be calculated based on landmarks at or near the subnasion and/or lips, and the upper and lower midline sections can be averaged to determine the facial midline 802.

Referring next to FIG. 8C, the 2D image may optionally be rotated so that the facial midline 802 is substantially vertical (e.g., within 5°, 2°, 1°, 0.5°, 0.1° of vertical, or exactly vertical) (the underlying 2D image is not shown in FIG. 8C). The rotated 2D image may then be used in subsequent image analysis processes, which may improve the accuracy and reliability of such processes. In other embodiments, however, the 2D image may be used without rotating so that the facial midline 802 is substantially vertical.

Additional details and examples of techniques for identifying facial landmarks in patient images and associated methods are provided in U.S. Pat. No. 12,202,288, the disclosure of which is incorporated by reference herein in its entirety.

Referring again to FIG. 6, tooth segmentation may be performed on the 2D image to generate a segmentation mask (block 606). The segmentation mask may be generated from the 2D image using any suitable technique, such as automatically via a segmentation algorithm (e.g., semantic segmentation algorithm, object instance segmentation algorithm, panoptic segmentation algorithm). For example, FIG. 7B is a representative example of a segmentation mask 706 overlaid on the photograph 700 of the patient's teeth, in accordance with embodiments of the present technology. The segmentation mask 706 includes tooth masks (e.g., contours) corresponding to the boundaries of the teeth of the upper jaw, including the central incisors 702.

Referring again to FIG. 6, the central incisor pair of the patient's teeth can then be identified (block 608). The identification can be based on the segmentation mask and the facial midline. For example, as shown in FIG. 7C, the identification process can include selecting a pair of adjacent teeth, and then checking whether the facial midline 708 overlaps with the selected tooth pair (e.g., based on the tooth boundaries defined by the segmentation mask 706). In the illustrated example, the facial midline 708 intersects the patient's right central incisor 702. Thus, there are two tooth pairs that overlap the facial midline 708: a first pair including the left and right central incisors 702, and a second pair including the right central incisor 702 and the right lateral incisor 710. For each of these two tooth pairs, a symmetry metric between the two teeth can be computed (e.g., a simple matching coefficient (SMC)), and the pair having the larger symmetry metric can be selected as the central incisor pair, since the central incisors 702 are expected to have a high degree of symmetry to each other.

Referring again to FIG. 6, a shift ratio can be calculated for the central incisor pair (block 610). The shift ratio can correspond to the distance between the facial midline and the midline of the central incisor pair (dental midline). For example, as shown in FIG. 7D, the shift ratio can be calculated using the equation

$$shift ratio = \frac{D}{( {W}_{L} + {W}_{R} ) / 2} ,$$

where D is the distance between the dental midline 712 and the facial midline 708, and W_{L} and W_{R} are the widths of the left and right central incisors 702, respectively. A large shift ratio may indicate that the patient has a significant dental midline shift.

FIG. 9 is a block diagram illustrating a workflow 900 for identifying an uneven smile, in accordance with embodiments of the present technology. In some embodiments, some or all of the processes described with respect to the workflow 900 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 900 can be utilized and/or combined with any of the other workflows and/or methods described herein (e.g., the workflow 100 of FIG. 1, the method 400 of FIG. 4, the workflow 500 of FIG. 5, and/or the workflow 600 of FIG. 6).

The workflow 900 can include accessing a 2D image of the patient, such as an anterior, full-face, and/or open mouth photograph (block 902), and finding a facial midline of the 2D image (block 904). The processes of blocks 902 and 904 may be identical or generally similar to the processes of blocks 602 and 604 of the workflow 600 of FIG. 6.

Lip segmentation may be performed on the 2D image to generate a lip mask (block 606). The lip mask can include geometric elements (e.g., points, lines, contours, areas) depicting the shape of the patient's mouth opening (e.g., the inner edges of the upper and lower lips). Lip segmentation may be performed using segmentation algorithms, based on identification of lip landmarks, or any other suitable method, such as the techniques described in U.S. Pat. No. 11,864,971, the disclosure of which is incorporated by reference herein in its entirety.

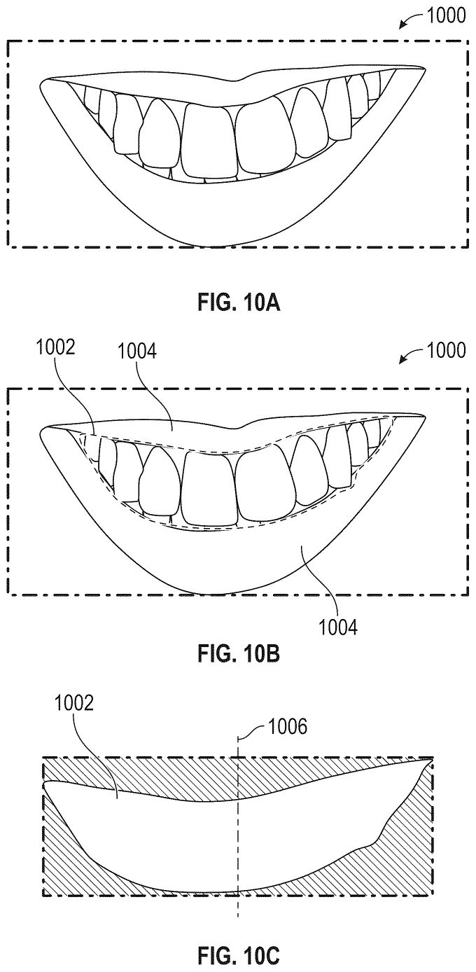

For example, FIG. 10A is a representative example of a photograph 1000 of a patient's teeth, and FIG. 10B illustrates a lip mask 1002 overlaid on the photograph 1000, in accordance with embodiments of the present technology. The lip mask 1002 includes contours corresponding to the lower edge of the upper lip 1004 and the upper edge of the lower lip 1004, which correlate to the shape of the patient's mouth opening.

Referring again to FIG. 9, a lip symmetry metric can be calculated based on the lip mask (block 908). The lip symmetry metric can quantify the degree of symmetry of the lips about the patient's facial midline, e.g., a low degree of symmetry may correlate to an uneven smile. For example, as shown in FIG. 10C, the facial midline 1006 can be overlaid onto the lip mask 1002 (represented by the white area). The degree of symmetry between the left and right parts of the lip mask 1002 as defined by the facial midline 1006 can be computed (e.g., using a SMC). If the left part of the lip mask 1002 has a low degree of symmetry with the right part of the lip mask 1002, the patient can be diagnosed as having an uneven smile.

Referring again to FIG. 9, uneven smile may alternatively or additionally be diagnosed based on the patient's teeth in the 2D image. In such embodiments, tooth segmentation may be performed on the 2D image to generate a segmentation mask (block 910), and the central incisor pair of the patient's teeth can be identified (block 912). The processes of blocks 910 and 912 may be identical or generally similar to the processes of blocks 606 and 608 of the workflow 600 of FIG. 6.

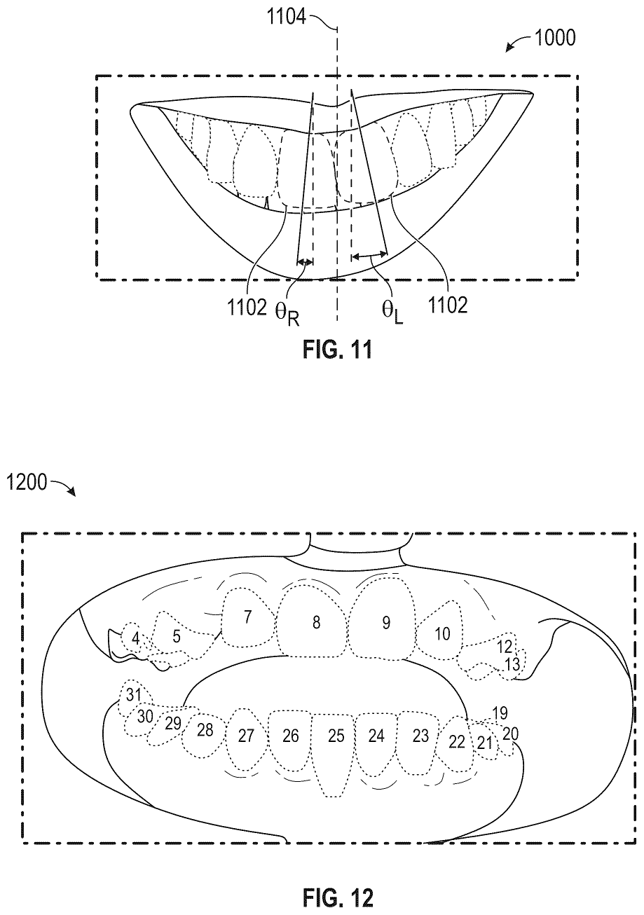

Incisor angulation can then be computed for the central incisor pair (block 914). The incisor angulation can characterize the angle of one or both central incisors relative to the facial midline, e.g., a high degree of incisor angulation may correlate to an uneven smile. For example, as shown in FIG. 11, incisor angulation can be calculated using the equation

$$incisor angle = \frac{\vert {θ}_{L} + {θ}_{R} \vert}{2}$$

where θ_{L} and θ_{R} are the angles between the left and right central incisors 1102, respectively, and the facial midline 1104. The orientation of the central incisors 1102 may be determined, for example, by applying principal component analysis (PCA) to the shape of each tooth. If one or both central incisors 1102 are at a large angle relative to the facial midline 1104, the patient can be diagnosed as having an uneven smile.

Although FIG. 9 illustrates two metrics for evaluating uneven smile-lip symmetry and incisor angulation-in other embodiments, a single metric may be used, such as lip symmetry only (in which case the processes of blocks 910-914 may be omitted) or incisor angulation only (in which case the processes of blocks 906 and 908 may be omitted).

FIG. 12 illustrates a representative example of a patient's teeth 1200 with an atypical gap due to a missing tooth, in accordance with embodiments of the present technology. A patient may be missing one or more teeth for various reasons, such as tooth extraction, natural loss of a primary tooth, tooth loss due to a disease or condition (e.g., tooth decay, periodontal disease, trauma), hypodontia, etc. For instance, in the illustrated example, the patient is missing tooth #6 and tooth #11, such that there is a gap in the upper jaw between tooth #5 and tooth #7, and between tooth #10 and tooth #12. The presence of a missing tooth may or may not be problematic, depending on the size of the gap between the teeth adjacent to the location of the missing tooth.

For example, if the neighboring teeth have been repositioned into the space left by the missing teeth (e.g., via orthodontic treatment with dental appliances), the gap between the neighboring teeth may be relatively small (e.g., within the typical range of tooth spacing) and/or may have little or no impact on the aesthetics and/or function of the teeth. Such gaps may not be considered to be “atypical” gaps and thus may not require any treatment. However, relatively large gaps between neighboring teeth (e.g., gaps that exceed the typical range of tooth spacing) and/or gaps that detrimentally affect the aesthetic appearance of the patient's teeth and/or interfere with the proper function of the teeth may be considered to be “atypical,” and treatment to close the gaps may be desired.

In some instances, detection of a missing tooth based on tooth identifiers alone may not be sufficient to determine whether the gap left by the missing tooth is atypical and should be corrected. Moreover, in some instances, simply measuring the distances between adjacent teeth may not be sufficient to detect atypical gaps, since the distances may vary according to the perspective of the image and/or the locations of the teeth in the mouth. Accordingly, to address these and other challenges, the present technology provides methods for identifying gaps due to missing teeth, and for distinguishing between atypical gaps (e.g., gaps that interfere with the aesthetics and/or function of the teeth) versus gaps that are within the typical range of tooth spacing and thus do not substantially affect the aesthetics and/or function of the teeth, based on various spatial parameters that may be measured from a segmentation mask of the teeth.

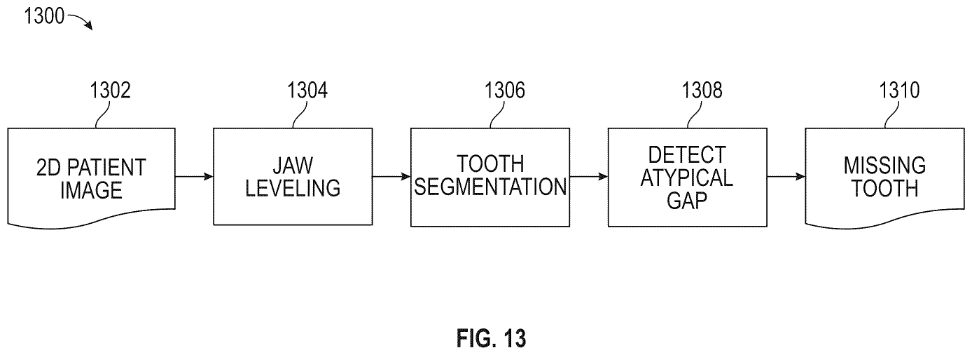

FIG. 13 is a block diagram illustrating a workflow 1300 for identifying an atypical gap and/or a missing tooth, in accordance with embodiments of the present technology. In some embodiments, some or all of the processes described with respect to the workflow 1300 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003. The workflow 1300 can be utilized and/or combined with any of the other workflows and/or methods described herein (e.g., the workflow 100 of FIG. 1, the method 400 of FIG. 4, the workflow 500 of FIG. 5, the workflow 600 of FIG. 6, and/or the workflow 900 of FIG. 9).

The workflow 1300 can include accessing a 2D image of the patient, such as an anterior, full-face, and/or open mouth photograph (block 1302). The process of block 1302 may be identical or generally similar to the process of block 602 of the workflow 600 of FIG. 6.

The workflow 1300 can then include performing a jaw leveling process (block 1304). The jaw leveling process can include adjusting the orientation of the 2D image so that the occlusal plane of the teeth is substantially horizontal and/or the facial midline is substantially vertical, which may improve the accuracy of the subsequent image analysis processes of the workflow 1300. Jaw leveling may be performed, for example, by determining one or more facial landmarks in the 2D image (e.g., as previously described with respect to FIG. 8A), determining a facial midline from the facial landmarks (e.g., as previously described with respect to FIG. 8B), and rotating the 2D image so that the facial midline is substantially vertical (e.g., as previously described with respect to FIG. 8C). In other embodiments, however, the jaw leveling process is optional and may be omitted from the workflow 1300.

The workflow 1300 can then include performing tooth segmentation on the 2D image to generate a segmentation mask (block 1306). The process of block 1306 may be identical or generally similar to the process of block 606 of the workflow 600 of FIG. 6.

The segmentation mask can then be analyzed to detect whether an atypical gap between teeth is present (block 1308). The detection of the atypical gap can involve measuring one or more spatial parameters of the teeth using the segmentation mask, and then determining whether the measured spatial parameters lie outside of a target range. For example, the target range can be a “typical” range that is determined based on measurements from a patient population, such that the gap is determined to be atypical if the value of the spatial parameter is not within the typical range. The spatial parameter can include a tooth distance (e.g., the distance between two neighboring teeth), a tooth size (e.g., the width of a tooth), or a combination thereof. In some embodiments, the spatial parameter includes a tooth distance to tooth width ratio (TD/TW ratio) that characterizes the relationship between (1) the distance between a tooth of interest and a neighboring tooth, and (2) the width of the tooth of interest.

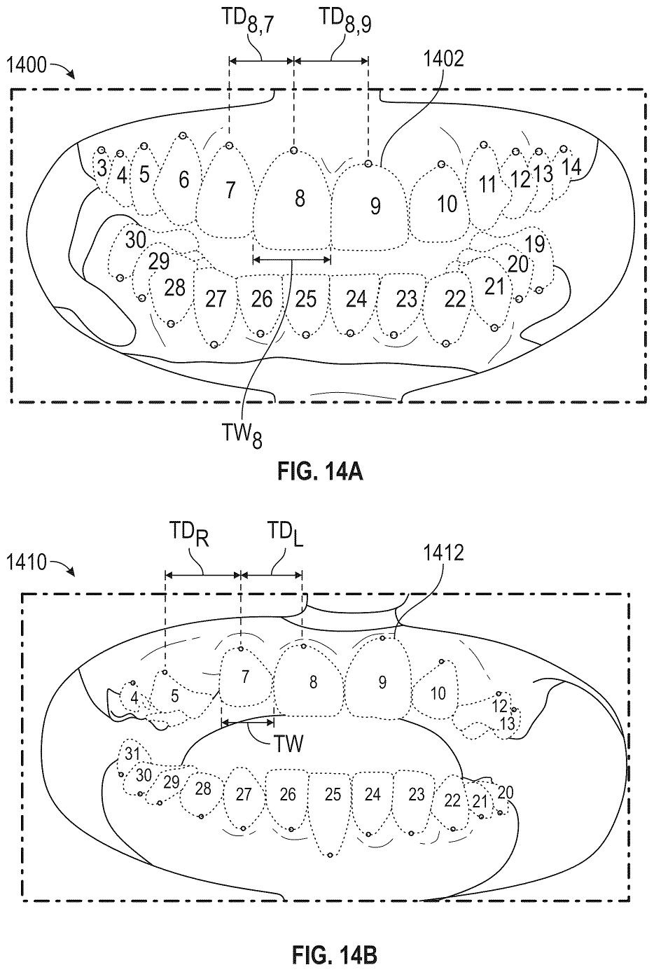

For example, FIGS. 14A and 14B illustrate a representative example of determination of an atypical gap from a patient photograph, in accordance with embodiments of the present technology. Specifically, FIG. 14A illustrates a sample patient photograph 1400 that may be used to determine typical ranges of TD/TW ratios, and FIG. 14B illustrates a test patient photograph 1410 in which an atypical gap is identified based on TD/TW ratios.

Referring first to FIG. 14A, a TD/TW ratio can be calculated for each tooth in a sample patient photograph 1400 as follows. First, a segmentation mask 1402 can be determined from the patient photograph 1400 using any suitable technique, such as automatically via a segmentation algorithm (e.g., semantic segmentation algorithm, object instance segmentation algorithm, panoptic segmentation algorithm). As shown in FIG. 14A, the segmentation mask 1402 can include tooth masks and tooth identifiers for each of the teeth. The tooth masks can be geometric elements (e.g., lines, contours, areas) representing the boundaries, shapes, and/or sizes of individual teeth, and the tooth identifiers can indicate the identity of each tooth mask (e.g., based on the universal numbering system or any other suitable dental notation scheme).

Subsequently, the segmentation mask 1402 can be used to calculate a TD/TW ratio for each tooth. A tooth width can be determined for each tooth by measuring the width of the corresponding tooth mask. The width of the tooth mask may be the maximum width of the tooth mask, the width of the tooth mask at the incisal edge, or any other suitable width measurement. For instance, FIG. 14A depicts the tooth width measurement for tooth #8 (TW₈). A tooth distance can be determined for each tooth by measuring the distance between the tooth mask for that tooth and the tooth mask for a neighboring tooth (e.g., the tooth immediately to the left or right of the tooth in the dental arch). The tooth distance can be calculated by measuring the distance between a reference location on the tooth mask and a reference location on the neighboring tooth mask, where the reference location may be the apex of the gingival border of the tooth mask, the midline of the tooth mask, or any other suitable location. For example, FIG. 14A depicts two tooth distance measurements for tooth #8—a tooth distance between tooth #8 and tooth #7 (TD_{8,7}) and a tooth distance between tooth #8 and tooth #9 (TD_{8,9}).

The tooth width and tooth distance values can then be used to calculate TD/TW ratios for each tooth according to the equations:

$$\frac{{TD}_{n , n - 1}}{{TW}_{n}} \qquad ( 1 )$$

$$\frac{{TD}_{n , n + 1}}{{TW}_{n}} \qquad ( 2 )$$

where equation (1) represents the TD/TW ratio between tooth n and tooth n−1, and equation (2) represents the TD/TW ratio between tooth n and tooth n+1. Thus, two TD/TW ratios may be calculated for each tooth (other than the distalmost teeth in the dental arch, which only have one neighboring tooth)—a first TD/TW ratio for the tooth and its neighboring tooth to the left, and a second TD/TW ratio for the tooth and its neighboring tooth to the right.

In some embodiments, a typical range for each TD/TW ratio is determined by calculating TD/TW ratios from a plurality of sample patient images (e.g., images that are representative of dentition without atypical gaps). The typical range may be characterized by a mean and standard deviation for each TD/TW ratio.

Referring next to FIG. 14B, the typical ranges of the TD/TW ratios may be compared to the actual TD/TW ratios for a test patient photograph 1410 to determine whether there are any atypical gaps in the teeth in the photograph 1410. Similar to the process of FIG. 14A, a segmentation mask 1412 can be determined from the patient photograph 1410, and a TD/TW ratio can be calculated for each tooth from the segmentation mask 1412. For example, FIG. 14B illustrates a tooth width measurement (TW) and tooth distance measurements (TD_{R}, TD_{L}) that may be used to calculate TD/TW ratios for tooth #7. Specifically, two TD/TW ratios may be calculated for tooth #7: a first TD/TW ratio between tooth #7 and the neighboring tooth to the right of tooth #7 (which is tooth #5 since tooth #6 is missing) (TD_{R}/TW) and a second TD/TW ratio between tooth #7 and the neighboring tooth to the left of tooth #7 (which is tooth #8) (TD_{L}/TW).

Each TD/TW ratio can then be compared to the typical range for that TD/TW ratio. If the TD/TW ratio lies outside of the typical range, this may indicate that an atypical gap is present. For instance, a TD/TW ratio may be considered to lie outside of the typical range if it is more than x standard deviations from the mean value of the typical range, where x may be 1, 2, 3, 4, 5, etc. In the illustrated example, because tooth #6 is missing, there is a large gap between tooth #7 and tooth #5, such that the tooth distance between tooth #7 and its neighbor to the right (TD_{R}) is larger than typical. Thus, the TD/TW ratio for tooth #7 and its neighbor to the right (TD_{R}/TW) is likely to be significantly larger than the typical values observed for that ratio, thus indicating that there is an atypical gap to the right of tooth #7.

Referring back to FIG. 13, if an atypical gap is detected, the workflow 1300 can optionally continue with identifying a missing tooth associated with the atypical gap (1310). In some embodiments, the missing tooth is identified by checking the tooth identifiers in the segmentation mask to determine if there are any missing teeth adjacent to the tooth with the atypical gap. For example, referring again to FIG. 14B, since an atypical gap was detected to the right of tooth #7 and the segmentation mask does not include tooth #6, tooth #6 can be identified as the missing tooth associated with the atypical gap.

Although the workflow 1300 of FIG. 13 is described in connection with identifying atypical gaps due to a missing tooth, the techniques described herein may alternatively or additionally be used to identify other dental conditions based on a TD/TW ratio. For instance, atypical tooth spacing may also be detected based on the TD/TW ratio, since teeth that are too close to each other or that are too far from each other may affect the measured tooth distances and thus may be detected by comparing the TD/TW ratio to the typical range for that ratio.

In some embodiments, the TD/TW ratio may be used to detect atypical tooth sizes (e.g., a chipped or broken tooth, macrodontia/microdontia). For example, a tooth that is significantly larger (e.g., wider) or smaller (e.g., narrower) than usual may affect the measured tooth widths and tooth distances. By calculating the TD/TW ratio for each tooth and comparing it against a typical range established from a representative population, it becomes possible to identify teeth whose size deviates from the norm. For instance, a tooth that is unusually wide will result in a lower TD/TW ratio, since the denominator (tooth width) increases relative to the distance between teeth. Conversely, a tooth that is unusually narrow will yield a higher TD/TW ratio, as the tooth width decreases in relation to the distance to neighboring teeth. Detection of such anomalies using the TD/TW ratio is valuable for diagnosing conditions such as macrodontia (abnormally large teeth) or microdontia (abnormally small teeth), which may impact both dental aesthetics and function. This information can be used in clinical decision-making, such as determining the need for restorative treatment (e.g., veneers or crowns to correct tooth size) or orthodontic interventions to adjust spacing and alignment. By systematically applying these ratio comparisons, practitioners can more objectively identify and document atypical tooth sizes, enhancing both diagnosis and treatment planning.

In some embodiments, the methods and systems disclosed herein may disambiguate between an atypical TD/TW ratio caused by an atypical gap and one caused by an atypical tooth size. Since both conditions (atypical gaps and atypical tooth sizes) can alter the TD/TW ratio, distinguishing the underlying cause may in some cases require a more comprehensive analysis using additional spatial parameters and contextual information from the segmentation mask. In some embodiments, the system may make a disambiguation determination based on a tooth's absolute width (TW). For example, if the TW is outside the typical range for that specific tooth (e.g., established from population data), and the adjacent tooth distances are within normal limits, the atypical TD/TW ratio may be determined to be due to atypical tooth size. Conversely, if the tooth width is normal but the distance to neighboring teeth (TD) is unusually large or small, the atypical ratio may be determined to be due to an atypical gap. In some embodiments, the system may make a disambiguation determination based on a comparison of neighboring TD/TW ratios. An atypical gap may typically affect ratios for both teeth bordering the atypical gap (e.g., referencing FIG. 14B, the TD/TW ratios of both tooth #5 and tooth #7 will be atypically high). By contrast, an atypical tooth size for a particular tooth may generally not affect the ratios of neighboring teeth (e.g., referencing FIG. 14B, if the TW of tooth #9 is atypically small, that affects the TD/TW ratios of tooth #9, but does not similarly affect the TD/TW ratios of neighboring teeth #8 and #10).

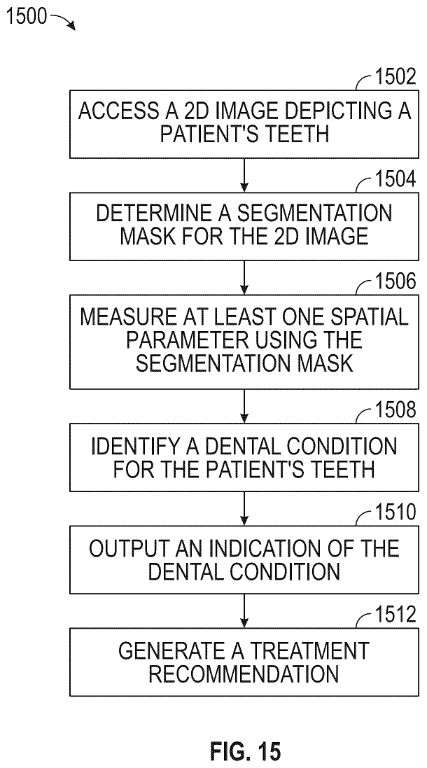

FIG. 15 is a flow diagram illustrating a method 1500 for identifying a dental condition of a patient's teeth, in accordance with embodiments of the present technology. In some embodiments, some or all of the processes of the method 1500 are implemented as computer-readable instructions (e.g., program code) that are configured to be executed by one or more processors of a computing device (e.g., a mobile device, laptop, personal computer, workstation, remote server). In some embodiments, the computing device is part of a virtual dental care system as described in, e.g., U.S. Patent Application Publication No. 2022/0023003. The method 1500 can be utilized and/or combined with any of the other workflows and/or methods described herein, such as the workflow 100 of FIG. 1, the method 400 of FIG. 4, the workflow 500 of FIG. 5, the workflow 600 of FIG. 6, the workflow 900 of FIG. 9, and/or the workflow 1300 of FIG. 13.

The method 1500 can begin at block 1502 with accessing at least one 2D image depicting a patient's teeth, e.g., as discussed above with respect to the 2D images 502 of FIG. 5. The process of block 1502 may be identical or generally similar to the process of block 402 of the method 400 of FIG. 4. For example, the 2D image can be a photograph or frame of a video obtained using an imaging device (e.g., a camera of a mobile device). The 2D image can depict the patient's teeth and/or other object features in the intraoral cavity from a particular view.

At block 1504, the method 1500 can include generating a segmentation mask of the patient's teeth, e.g., as discussed above with respect to the segmentation mask 504 of FIG. 5. For example, the segmentation mask can include a plurality of tooth masks corresponding a plurality of individual teeth of the patient and, optionally, a plurality of tooth identifiers for the tooth masks. Optionally, the segmentation mask can include geometric elements (e.g., points, lines, contours, areas) corresponding to the boundaries, shapes, and/or sizes of other object features of the intraoral cavity, such as a lip mask corresponding to the patient's mouth opening.

At block 1506, the method 1500 can include measuring at least one spatial parameter using the segmentation mask e.g., as discussed above with respect to the spatial parameters 506 of FIG. 5. For instance, the spatial parameter can include a geometry of an object feature of the intraoral cavity and/or a spatial relationship between two or more object features of the intraoral cavity. The object features can include a tooth, a gum, a lip, a facial midline (or other anatomical reference line), a dental auxiliary, a dental appliance, or a combination thereof. In some embodiments, the spatial parameters include a shape of an object feature, a size of an object feature, a distance of an object feature with respect to another object feature, or an angle of an object feature with respect to another object feature.

At block 1508, the method 1500 can continue with identifying a dental condition for the patient's teeth, based on the at least one spatial parameter. Examples of dental conditions that may be identified include dental midline shift (e.g., as discussed with respect to FIGS. 6-8C), uneven smile (e.g., as discussed with respect to FIGS. 9-11), atypical gaps and/or missing teeth (e.g., as discussed with respect to FIGS. 12-14B), tooth crowding, tooth spacing, overjet, overbite, underbite, crossbite, open bite, deep bite, narrow arch, tooth wear, abfraction, atypical tooth size (e.g., short clinical crowns), periodontitis, and/or gum recession. The dental condition may be identified based on the value of the spatial parameter (e.g., by comparing the value of the spatial parameter to a threshold value associated with the dental condition), based on the values of two or more spatial parameters (e.g., by comparing the values to each other; by summing, subtracting, multiplying, dividing, or otherwise combining the values via any suitable mathematical operation), based on statistics calculated from the values of two or more spatial parameters (e.g., averages, medians, standard deviations), or suitable combinations thereof. In some embodiments, spatial parameters calculated from a single segmentation mask are used to evaluate the patient for a plurality of different dental conditions, such as two, three, four, five, or more different dental conditions.

At block 1510, the method 1500 can include outputting an indication of the dental condition via a display. The process of block 1510 may be identical or generally similar to the process of block 410 of the method 400 of FIG. 4. For instance, the indication can be displayed on a monitor or screen that is associated with a computing device (e.g., a mobile device, personal computer, laptop, tablet, workstation). The indication of the dental condition can be provided in any suitable format, such as textually, numerically, graphically, etc.

At block 1512, the method 1500 can include generating a treatment recommendation, based on the dental condition. The process of block 1512 may be identical or generally similar to the process of block 412 of the method 400 of FIG. 4. For example, the treatment recommendation can be output to a user, e.g., via the same display used for the indication of the dental condition. The treatment recommendation can include a recommended action for addressing the dental condition, such as any of the following: a recommendation that the patient come in for an in-person appointment, a recommendation that the patient take additional 2D images for further analysis, a recommendation of a particular treatment type (e.g., dental appliances, improved oral hygiene practices, surgical interventions), a recommendation of a particular treatment timing (e.g., treatment is needed immediately, treatment is not needed immediately but continued monitoring is recommended), etc. Alternatively or in combination, the treatment recommendation can include a recommended action with respect to a planned dental treatment for the patient in view of the patient's dental condition, such as one or more of the following: a recommendation that the patient's teeth are ready for treatment, a recommendation that treatment should be delayed, a recommendation of a type of treatment for the patient's teeth, or a recommendation that the patient's teeth are not suitable for a type of treatment.

For example, if the patient is diagnosed with a dental midline shift, the treatment recommendation can include orthodontic treatment (e.g., via one or more dental appliances configured to reposition the teeth so that the dental midline is more aligned with the facial midline) and/or restorative treatment (e.g., via one or more restorative objects applied to change the shape of the teeth to bring the dental midline into alignment with the facial midline). As another example, if the patient is diagnosed with an uneven smile, the treatment recommendation can include orthodontic treatment (e.g., via one or more dental appliances configured to correct the central incisor angulation), restorative treatment (e.g., via one or more restorative objects applied to the teeth to produce a more symmetric smile), and/or lip fillers to alter the shape of the patient's lips (e.g., if the uneven smile is attributable at least in part to the shape of the mouth opening). In a further example, if the patient is diagnosed with an atypical gap and/or a missing tooth, the treatment recommendation can include orthodontic treatment (e.g., via one or more dental appliances configured to reposition teeth adjacent to the gap to reduce the size of the gap) and/or restorative treatment (e.g., via a prosthetic tooth or other restorative object placed into the gap to replace the missing tooth). Optionally, if a gap between teeth is identified, but the gap is relatively small and thus is not considered atypical (e.g., the gap is within the normal range for tooth spacing and/or does not substantially affect the aesthetics and/or function of the teeth), the treatment recommendation can indicate that a gap is present but no treatment is needed.

The method 1500 illustrated in FIG. 15 can be modified in many different ways. For example, although the above processes of the method 1500 are described with respect to a single 2D image, the method 1500 can be applied sequentially or concurrently to any suitable number of images. As another example, the ordering of the processes shown in FIG. 15 can be varied, or some processes may be performed concurrently. In some embodiments, the method 1500 may be performed on a remote server (e.g., a server computing device). For example, a patient or doctor device (e.g., a smartphone) may be used to capture a 2D image, and this 2D image may be transmitted to the remote server (e.g., via a smartphone application). The remote server may then execute any of the processes of blocks 1504-1512. In other embodiments, the method 1500 may be entirely performed on a local client device (e.g., a mobile device, a personal computer). In some embodiments, some of the steps may be performed on a remote server, and some of the steps may be performed on a local client device. Some of the processes of the method 1500 can be omitted (e.g., the process of block 1510 and/or block 1512) and/or the method 1500 can include additional processes not shown in FIG. 15 (e.g., administering a treatment to the patient according to the treatment recommendation of block 1512).

### II. Dental Appliances and Associated Methods

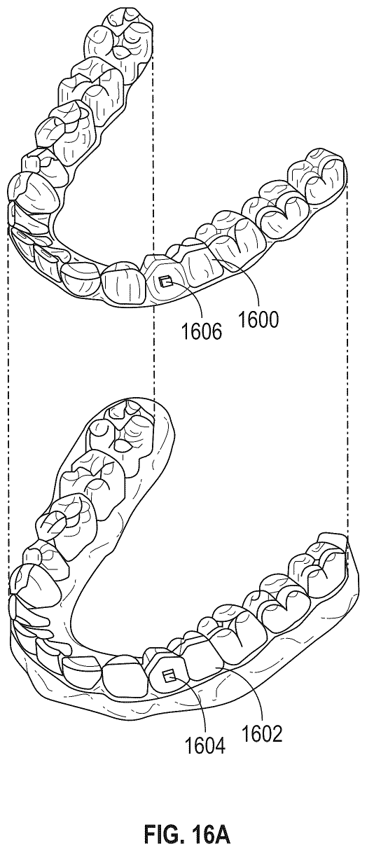

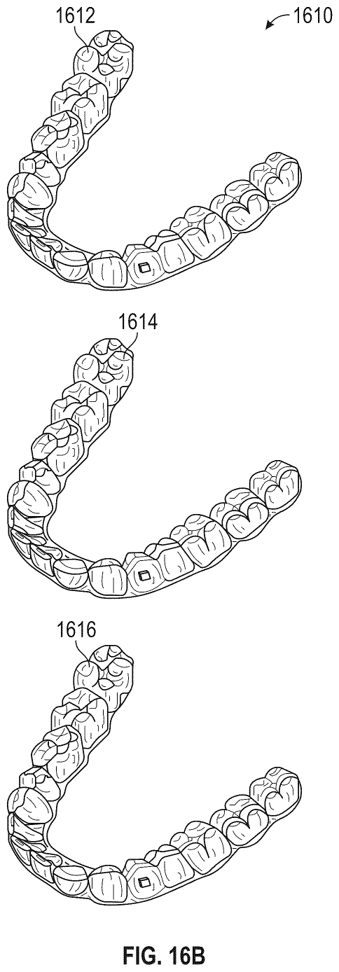

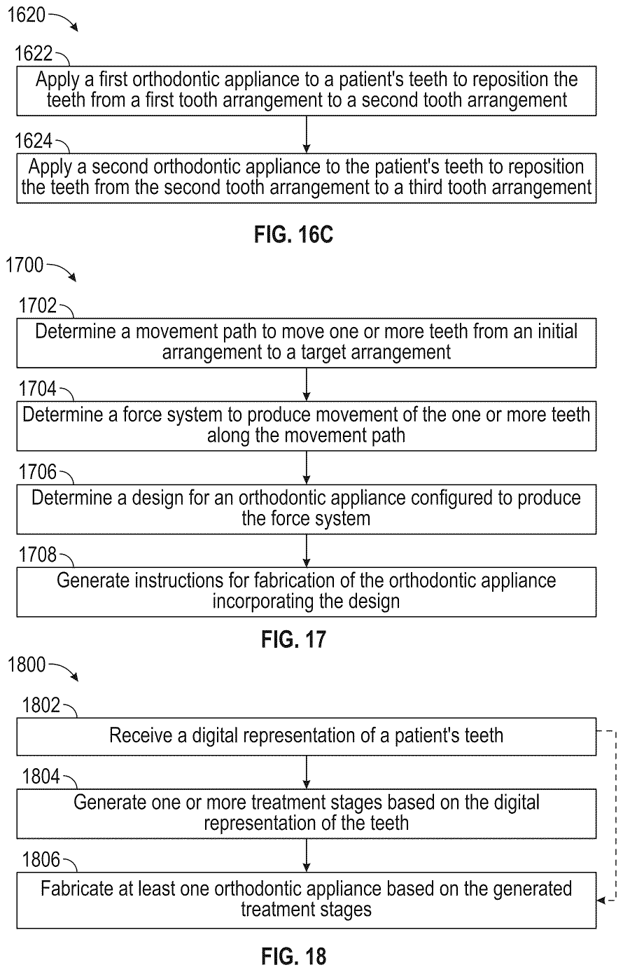

FIG. 16A illustrates a representative example of a tooth repositioning appliance 1600 configured in accordance with embodiments of the present technology. The appliance 1600 can be used in combination with any of the systems, methods, and devices described herein. The appliance 1600 (also referred to herein as an “aligner”) can be worn by a patient in order to achieve an incremental repositioning of individual teeth 1602 in the jaw. The appliance 1600 can include a shell (e.g., a continuous polymeric shell or a segmented shell) having teeth-receiving cavities that receive and resiliently reposition the teeth. The appliance 1600 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1600 can fit over all teeth present in an upper or lower jaw, or less than all of the teeth. The appliance 1600 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1600 can be a generic appliance configured to receive the teeth, but not necessarily shaped to match the topography of the patient's teeth. In some cases, only certain teeth received by the appliance 1600 are repositioned by the appliance 1600 while other teeth can provide a base or anchor region for holding the appliance 1600 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1600 in place over the teeth. In some cases, however, it may be desirable or necessary to provide individual attachments 1604 or other anchoring elements on teeth 1602 with corresponding receptacles 1606 or apertures in the appliance 1600 so that the appliance 1600 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 16B illustrates a tooth repositioning system 1610 including a plurality of appliances 1612, 1614, 1616, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1610 can include a first appliance 1612 corresponding to an initial tooth arrangement, one or more intermediate appliances 1614 corresponding to one or more intermediate arrangements, and a final appliance 1616 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 16C illustrates a method 1620 of orthodontic treatment using a plurality of appliances, in accordance with embodiments of the present technology. The method 1620 can be practiced using any of the appliances or appliance sets described herein. In block 1622, a first orthodontic appliance is applied to a patient's teeth in order to reposition the teeth from a first tooth arrangement to a second tooth arrangement. In block 1624, a second orthodontic appliance is applied to the patient's teeth in order to reposition the teeth from the second tooth arrangement to a third tooth arrangement. The method 1620 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 17 illustrates a method 1700 for designing an orthodontic appliance, in accordance with embodiments of the present technology. The method 1700 can be applied to any embodiment of the orthodontic appliances described herein. Some or all of the steps of the method 1700 can be performed by any suitable data processing system or device, e.g., one or more processors configured with suitable instructions.

In block 1702, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1704, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1704 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1706, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1708, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1700 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1700 may be performed with any suitable fabrication system or device, such as the embodiments described herein. Some of the steps may be optional, e.g., the process of block 1704 can be omitted, such that the orthodontic appliance is designed based on the desired tooth movements and/or determined tooth movement path, rather than based on a force system. Moreover, the order of the steps can be varied as desired.

FIG. 18 illustrates a method 1800 for digitally planning an orthodontic treatment and/or design or fabrication of an appliance, in accordance with embodiments. The method 1800 can be applied to any of the treatment procedures described herein and can be performed by any suitable data processing system.

In block 1802, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1804, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1806, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 18, design and/or fabrication of an orthodontic appliance, and perhaps a particular orthodontic treatment, may include use of a representation of the patient's teeth (e.g., including receiving a digital representation of the patient's teeth (block 1802)), followed by design and/or fabrication of an orthodontic appliance based on a representation of the patient's teeth in the arrangement represented by the received representation.

As noted herein, the techniques described herein can be used in combination with directly fabricated dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used in combination with attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used in combination with incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### Examples

The following examples are included to further describe some aspects of the present technology, and should not be used to limit the scope of the technology.
Example 1. A system for identifying a dental condition from a patient image, the system comprising:
   one or more processors; and
   a memory storing instructions that, when executed by the one or more processors, cause the system to perform operations comprising:
      accessing a 2D image depicting a patient's teeth;
      generating a 3D digital model of the patient's teeth, based on the 2D image;
      measuring at least one spatial parameter using the 3D digital model, wherein the at least one spatial parameter comprises one or more of a geometry of an object feature in an intraoral cavity of the patient or a spatial relationship between two or more object features in the intraoral cavity of the patient; and
      identifying a dental condition for the patient's teeth based on the at least one spatial parameter.
Example 2. The system of Example 1, wherein the at least one spatial parameter is measured with respect to one or more of the following object features: a tooth, a gum, a lip, a facial midline, a dental midline, a dental auxiliary, a dental appliance, or a combination thereof.
Example 3. The system of Example 1 or 2, wherein the at least one spatial parameter comprises one or more of the following: a shape of an object feature, a size of an object feature, a distance of an object feature with respect to another object feature, or an angle of an object feature with respect to another object feature.
Example 4. The system of any one of Examples 1 to 3, wherein the operations further comprise causing a display of an indication of the dental condition on a display device.
Example 5. The system of Example 4, wherein the display device is remote from the one or more processors.
Example 6. The system of Example 4 or 5, wherein the indication of the dental condition comprises an indication of a location of the dental condition on the patient's teeth in the 2D image.
Example 7. The system of any one of Examples 1 to 6, wherein the dental condition comprises one or more of the following: tooth crowding, tooth spacing, overjet, overbite, underbite, crossbite, open bite, deep bite, narrow arch, tooth wear, abfraction, atypical tooth size, periodontitis, or gum recession.
Example 8. The system of Example 7, wherein the at least one spatial parameter comprises an arch length for one or more teeth and a tooth width for each of the one or more teeth, and wherein the dental condition is tooth crowding.
Example 9. The system of Example 7, wherein the at least one spatial parameter comprises an arch width, and wherein the dental condition comprises a narrow arch.
Example 10. The system of any one of Examples 1 to 9, wherein the operations further comprise generating a treatment recommendation based on the identified dental condition.
Example 11. The system of Example 10, wherein the treatment recommendation comprises one or more of: a recommendation that the patient's teeth are ready for treatment, a recommendation that treatment should be delayed, a recommendation of a type of treatment for the patient's teeth, or a recommendation that the patient's teeth are not suitable for a type of treatment.
Example 12. The system of any one of Examples 1 to 11, wherein the at least one spatial parameter is measured with respect to an object feature within the intraoral cavity of the patient that is obscured in the 2D image.
Example 13. The system of Example 12, wherein the 2D image depicts a buccal view of the patient's teeth and the at least one spatial feature is measured with respect to one or more of an occlusal surface or a lingual surface of the patient's teeth.
Example 14. The system of Example 12, wherein the 2D image depicts an anterior view of the patient's teeth and the at least one spatial feature is measured with respect to one or more posterior teeth of the patient's teeth.
Example 15. The system of any one of Examples 1 to 14, wherein: the 2D image is a first 2D image depicting a first view of the patient's teeth, the operations further comprise accessing at least one second 2D image of the patient's teeth, the at least one second 2D image depicting at least one second view of the patient's teeth that is different from the first view, and the 3D digital model is generated based on the first 2D image and the at least one second 2D image.
Example 16. The system of any one of Examples 1 to 15, wherein the 3D digital model is generated without using scan data of the patient's teeth.
Example 17. The system of any one of Examples 1 to 16, wherein the 3D digital model is generated without using a previously generated 3D digital model of patient's teeth.
Example 18. The system of any one of Examples 1 to 17, wherein the 3D digital model is generated by:
accessing a generic 3D digital model depicting teeth with generic parameters, determining patient-specific parameters for the patient's teeth based on a registration between the generic 3D digital model and the 2D image, and producing the 3D digital model by adjusting the teeth of the generic 3D digital model according to the patient-specific parameters.
Example 19. The system of any one of Examples 1 to 18, wherein the 2D image comprises a photograph or a frame of a video.
Example 20. The system of any one of Examples 1 to 19, wherein the 2D image is obtained from an imaging device that is remote from the one or more processors.
Example 21. The system of Example 20, wherein the imaging device comprises a camera that is part of or is operably coupled to a mobile device.
Example 22. The system of any one of Examples 1 to 21, wherein the one or more processors are part of a local client device.
Example 23. The system of any one of Examples 1 to 21, wherein the one or more processors are part of a server computing device.
Example 24. A computer-implemented method for identifying a dental condition from a patient image, the computer-implemented method comprising, by one or more processors: accessing a 2D image depicting a patient's teeth;
   transmitting the 2D image to a server computing device; and
   receiving a diagnosis of a dental condition for the patient's teeth from the server computing device, wherein the server computing device is configured to determine the diagnosis by:
      generating a 3D digital model of the patient's teeth, based on the 2D image,
      measuring at least one spatial parameter using the 3D digital model, wherein the at least one spatial parameter comprises one or more of a geometry of an object feature in an intraoral cavity of the patient or a spatial relationship between two or more object features in the intraoral cavity of the patient, and
      identifying the dental condition for the patient's teeth based on the at least one spatial parameter.
Example 25. The computer-implemented method of Example 24, wherein the at least one spatial parameter is measured with respect to one or more of the following object features: a tooth, a gum, a lip, a facial midline, a dental midline, a dental auxiliary, a dental appliance, or a combination thereof.
Example 26. The computer-implemented method of Example 24 or 25, wherein the at least one spatial parameter comprises one or more of the following: a shape of an object feature, a size of an object feature, a distance of an object feature with respect to another object feature, or an angle of an object feature with respect to another object feature.
Example 27. The computer-implemented method of any one of Examples 24 to 26, further comprising displaying an indication of the dental condition on a display device.
Example 28. The computer-implemented method of Example 27, wherein the indication of the dental condition comprises an indication of a location of the dental condition on the patient's teeth in the 2D image.
Example 29. The computer-implemented method of any one of Examples 24 to 28, wherein the dental condition comprises one or more of the following: tooth crowding, tooth spacing, overjet, overbite, underbite, crossbite, open bite, deep bite, narrow arch, tooth wear, abfraction, atypical tooth size, periodontitis, or gum recession.
Example 30. The computer-implemented method of Example 29, wherein the at least one spatial parameter comprises an arch length for one or more teeth and a tooth width for each of the one or more teeth, and wherein the dental condition is tooth crowding.
Example 31. The computer-implemented method of Example 29, wherein the at least one spatial parameter comprises an arch width, and wherein the dental condition comprises a narrow arch.
Example 32. The computer-implemented method of any one of Examples 24 to 31, further comprising receiving a treatment recommendation from the server computing device.
Example 33. The computer-implemented method of Example 32, wherein the treatment recommendation comprises one or more of: a recommendation that the patient's teeth are ready for treatment, a recommendation that treatment should be delayed, a recommendation of a type of treatment for the patient's teeth, or a recommendation that the patient's teeth are not suitable for a type of treatment.
Example 34. The computer-implemented method of any one of Examples 24 to 33, wherein the at least one spatial parameter is measured with respect to an object feature within the intraoral cavity of the patient that is obscured in the 2D image.
Example 35. The computer-implemented method of Example 34, wherein the 2D image depicts a buccal view of the patient's teeth and the at least one spatial feature is measured with respect to one or more of an occlusal surface or a lingual surface of the patient's teeth.
Example 36. The computer-implemented method of Example 34, wherein the 2D image depicts an anterior view of the patient's teeth and the at least one spatial feature is measured with respect to one or more posterior teeth of the patient's teeth.
Example 37. The computer-implemented method of any one of Examples 24 to 36, wherein:
   the 2D image is a first 2D image depicting a first view of the patient's teeth,
   the computer-implemented method further comprises accessing at least one second 2D image of the patient's teeth, the at least one second 2D image depicting at least one second view of the patient's teeth that is different from the first view, and
   the 3D digital model is generated based on the first 2D image and the at least one second 2D image.
Example 38. The computer-implemented method of any one of Examples 24 to 37, wherein the 3D digital model is generated without using scan data of the patient's teeth.
Example 39. The computer-implemented method of any one of Examples 24 to 38, wherein the 3D digital model is generated without using a previously generated 3D digital model of patient's teeth.
Example 40. The computer-implemented method of any one of Examples 24 to 39, wherein the 3D digital model is generated by:

accessing a generic 3D digital model depicting teeth with generic parameters, determining patient-specific parameters for the patient's teeth based on a registration between the generic 3D digital model and the 2D image, and producing the 3D digital model by adjusting the teeth of the generic 3D digital model according to the patient-specific parameters.
Example 41. The computer-implemented method of any one of Examples 24 to 40, wherein the 2D image comprises a photograph or a frame of a video.
Example 42. The computer-implemented method of any one of Examples 24 to 41, wherein the 2D image is obtained from a camera that is part of or is operably coupled to a mobile device.
Example 43. A computer-implemented method for identifying a dental condition from a patient image, the computer-implemented method comprising, by one or more processors: accessing a 2D image depicting a patient's teeth;
   generating a 3D digital model of the patient's teeth, based on the 2D image;
   measuring at least one spatial parameter using the 3D digital model, wherein the at least one spatial parameter comprises one or more of a geometry of an object feature in an intraoral cavity of the patient or a spatial relationship between two or more object features in the intraoral cavity of the patient; and
   identifying a dental condition for the patient's teeth based on the at least one spatial parameter.
Example 44. The computer-implemented method of Example 43, wherein the at least one spatial parameter is measured with respect to one or more of the following object features: a tooth, a gum, a lip, a facial midline, a dental midline, a dental auxiliary, a dental appliance, or a combination thereof.
Example 45. The computer-implemented method of Example 43 or 44, wherein the at least one spatial parameter comprises one or more of the following: a shape of an object feature, a size of an object feature, a distance of an object feature with respect to another object feature, or an angle of an object feature with respect to another object feature.
Example 46. The computer-implemented method of any one of Examples 43 to 45, further comprising causing a display of an indication of the dental condition on a display device.
Example 47. The computer-implemented method of Example 46, wherein the display device is remote from the one or more processors.
Example 48. The computer-implemented method of Example 46, wherein the indication of the dental condition comprises an indication of a location of the dental condition on the patient's teeth in the 2D image.
Example 49. The computer-implemented method of any one of Examples 43 to 48, wherein the dental condition comprises one or more of the following: tooth crowding, tooth spacing, overjet, overbite, underbite, crossbite, open bite, deep bite, narrow arch, tooth wear, abfraction, atypical tooth size, periodontitis, or gum recession.
Example 50. The computer-implemented method of Example 49, wherein the at least one spatial parameter comprises an arch length for one or more teeth and a tooth width for each of the one or more teeth, and wherein the dental condition is tooth crowding.
Example 51. The computer-implemented method of Example 49, wherein the at least one spatial parameter comprises an arch width, and wherein the dental condition comprises a narrow arch.
Example 52. The computer-implemented method of any one of Examples 43 to 51, further comprising generating a treatment recommendation based on the identified dental condition.
Example 53. The computer-implemented method of Example 52, wherein the treatment recommendation comprises one or more of: a recommendation that the patient's teeth are ready for treatment, a recommendation that treatment should be delayed, a recommendation of a type of treatment for the patient's teeth, or a recommendation that the patient's teeth are not suitable for a type of treatment.
Example 54. The computer-implemented method of any one of Examples 43 to 53, wherein the at least one spatial parameter is measured with respect to an object feature within the intraoral cavity of the patient that is obscured in the 2D image.
Example 55. The computer-implemented method of Example 54, wherein the 2D image depicts a buccal view of the patient's teeth and the at least one spatial feature is measured with respect to one or more of an occlusal surface or a lingual surface of the patient's teeth.
Example 56. The computer-implemented method of Example 54, wherein the 2D image depicts an anterior view of the patient's teeth and the at least one spatial feature is measured with respect to one or more posterior teeth of the patient's teeth.
Example 57. The computer-implemented method of any one of Examples 43 to 56, wherein:
   the 2D image is a first 2D image depicting a first view of the patient's teeth,
   the computer-implemented method further comprises accessing at least one second 2D image of the patient's teeth, the at least one second 2D image depicting at least one second view of the patient's teeth that is different from the first view, and
   the 3D digital model is generated based on the first 2D image and the at least one second 2D image.
Example 58. The computer-implemented method of any one of Examples 43 to 57, wherein the 3D digital model is generated without using scan data of the patient's teeth.
Example 59. The computer-implemented method of any one of Examples 43 to 58, wherein the 3D digital model is generated without using a previously generated 3D digital model of patient's teeth.
Example 60. The computer-implemented method of any one of Examples 43 to 59, wherein the 3D digital model is generated by:
   accessing a generic 3D digital model depicting teeth with generic parameters,
   determining patient-specific parameters for the patient's teeth based on a registration between the generic 3D digital model and the 2D image, and
   producing the 3D digital model by adjusting the teeth of the generic 3D digital model according to the patient-specific parameters.
Example 61. The computer-implemented method of any one of Examples 43 to 60, wherein the 2D image comprises a photograph or a frame of a video.
Example 62. The computer-implemented method of any one of Examples 43 to 61, wherein the 2D image is obtained from an imaging device that is remote from the one or more processors.
Example 63. The computer-implemented method of Example 62, wherein the imaging device comprises a camera that is part of or is operably coupled to a mobile device.
Example 64. A non-transitory computer-readable storage medium comprising instructions that, when executed by one or more processors of a computing system, cause the computing system to perform operations comprising:
   accessing a 2D image depicting a patient's teeth;
   generating a 3D digital model of the patient's teeth, based on the 2D image;
   measuring at least one spatial parameter using the 3D digital model, wherein the at least one spatial parameter comprises one or more of a geometry of an object feature in an intraoral cavity of the patient or a spatial relationship between two or more object features in the intraoral cavity of the patient; and
   identifying a dental condition for the patient's teeth based on the at least one spatial parameter.
Example 65. The non-transitory computer-readable storage medium of Example 64, wherein the operations further comprise causing a display of an indication of the dental condition on a display device.
Example 66. The non-transitory computer-readable storage medium of Example 64 or 65, wherein the dental condition comprises one or more of the following: tooth crowding, tooth spacing, overjet, overbite, underbite, crossbite, open bite, deep bite, narrow arch, tooth wear, abfraction, atypical tooth size, periodontitis, or gum recession.
Example 67. The non-transitory computer-readable storage medium of any one of Examples 64 to 66, wherein the operations further comprise generating a treatment recommendation based on the identified dental condition.
Example 68. The non-transitory computer-readable storage medium of any one of Examples 64 to 67, wherein the at least one spatial parameter is measured with respect to an object feature within the intraoral cavity of the patient that is obscured in the 2D image.
Example 69. The non-transitory computer-readable storage medium of any one of Examples 64 to 68, wherein:
   the 2D image is a first 2D image depicting a first view of the patient's teeth,
   the computer-implemented method further comprises accessing at least one second 2D image of the patient's teeth, the at least one second 2D image depicting at least one second view of the patient's teeth that is different from the first view, and
   the 3D digital model is generated based on the first 2D image and the at least one second 2D image.
Example 70. The non-transitory computer-readable storage medium of any one of Examples 64 to 69, wherein the 2D image comprises a photograph or a frame of a video.
Example 71. A system for identifying a dental condition from a patient image, the system comprising:
   one or more processors; and
   a memory storing instructions that, when executed by the one or more processors, cause the system to perform operations comprising:
      accessing a 2D image depicting a patient's teeth;
      determining a segmentation mask for the 2D image, the segmentation mask including a plurality of tooth masks corresponding to a plurality of individual teeth of the patient's teeth;
      measuring at least one spatial parameter using the segmentation mask, wherein the at least one spatial parameter comprises one or more of a shape of an object feature in an intraoral cavity of the patient or a spatial relationship between two or more object features in the intraoral cavity of the patient; and
      identifying a dental condition for the patient's teeth based on the at least one spatial parameter.
Example 72. The system of Example 71, wherein the at least one spatial parameter comprises a central incisor shift ratio, and wherein the dental condition comprises a dental midline shift.
Example 73. The system of Example 72, wherein the operations further comprise: identifying a pair of tooth masks of the plurality of tooth masks corresponding to a pair of central incisors of the patient, and measuring the central incisor shift ratio using the pair of tooth masks.
Example 74. The system of any one of Examples 71 to 73, wherein the at least one spatial parameter comprises central incisor angulation, and wherein the dental condition comprises an uneven smile.
Example 75. The system of Example 74, wherein the operations further comprise: identifying a pair of tooth masks of the plurality of tooth masks corresponding to a pair of central incisors of the patient, and measuring the central incisor angulation using the pair of tooth masks.
Example 76. The system of any one of Examples 71 to 75, wherein the at least one spatial parameter comprises a tooth distance to tooth width ratio, and wherein the dental condition comprises an atypical gap in the patient's teeth.
Example 77. The system of Example 76, wherein the atypical gap is due to a missing tooth.
Example 78. The system of Example 76 or 77, wherein the operations further comprise:
   measuring the tooth distance to tooth width ratio for a tooth of the patient, and
   comparing the measured tooth distance to tooth width for the tooth to a typical range for the tooth distance to tooth width ratio for the tooth.
Example 79. The system of Example 78, wherein the operations further comprise identifying the atypical gap in response to the measured tooth distance to tooth width ratio being outside of the typical range.
Example 80. The system of any one of Examples 71 to 79, wherein the operations further comprise identifying a facial midline of the patient in the 2D image.
Example 81. The system of Example 80, wherein the operations further comprise rotating the 2D image so that the facial midline is substantially vertical, before determining the segmentation mask.
Example 82. The system of any one of Examples 71 to 81, wherein: the segmentation mask further comprises a lip mask corresponding to a shape of the patient's lips, the at least one spatial parameter comprises lip symmetry, and the dental condition comprises an uneven smile.
Example 83. The system of any one of Examples 71 to 82, wherein the operations further comprise causing a display of an indication of the dental condition on a display device.
Example 84. The system of Example 83, wherein the display device is remote from the one or more processors.
Example 85. The system of any one of Examples 71 to 84, wherein the operations further comprise generating a treatment recommendation based on the identified dental condition.
Example 86. The system of any one of Examples 71 to 85, wherein the 2D image comprises a photograph or a frame of a video.
Example 87. The system of any one of Examples 71 to 86, wherein the 2D image is obtained from an imaging device that is remote from the one or more processors.
Example 88. The system of Example 87, wherein the imaging device comprises a camera that is part of or is operably coupled to a mobile device.
Example 89. The system of any one of Examples 71 to 88, wherein the one or more processors are part of a local client device.
Example 90. The system of any one of Examples 71 to 88, wherein the one or more processors are part of a server computing device.
Example 91. A computer-implemented method for identifying a dental condition from a patient image, the computer-implemented method comprising, by one or more processors: accessing a 2D image depicting a patient's teeth;
   transmitting the 2D image to a server computing device; and
   receiving a diagnosis of a dental condition for the patient's teeth from the server computing device, wherein the server computing device is configured to determine the diagnosis by:
      determining a segmentation mask for the 2D image, the segmentation mask including a plurality of tooth masks corresponding to a plurality of individual teeth of the patient's teeth,
      measuring at least one spatial parameter using the segmentation mask, wherein the at least one spatial parameter comprises one or more of a shape of an object feature in an intraoral cavity of the patient or a spatial relationship between two or more object features in the intraoral cavity of the patient, and
      identifying a dental condition for the patient's teeth based on the at least one spatial parameter.
Example 92. The computer-implemented method of Example 91, wherein the at least one spatial parameter comprises a central incisor shift ratio, and wherein the dental condition comprises a dental midline shift.
Example 93. The computer-implemented method of Example 92, wherein the diagnosis is determined by:
   identifying a pair of tooth masks of the plurality of tooth masks corresponding to a pair of central incisors of the patient, and
   measuring the central incisor shift ratio using the pair of tooth masks.
Example 94. The computer-implemented method of any one of Examples 91 to 93, wherein the at least one spatial parameter comprises central incisor angulation, and wherein the dental condition comprises an uneven smile.
Example 95. The computer-implemented method of Example 94, wherein the diagnosis is determined by:
   identifying a pair of tooth masks of the plurality of tooth masks corresponding to a pair of central incisors of the patient, and
   measuring the central incisor angulation using the pair of tooth masks.
Example 96. The computer-implemented method of any one of Examples 91 to 95, wherein the at least one spatial parameter comprises a tooth distance to tooth width ratio, and wherein the dental condition comprises an atypical gap in the patient's teeth.
Example 97. The computer-implemented method of Example 96, wherein the atypical gap is due to a missing tooth.
Example 98. The computer-implemented method of Example 96 or 97, wherein the diagnosis is determined by:
   measuring the tooth distance to tooth width ratio for a tooth of the patient, and
   comparing the measured tooth distance to tooth width for the tooth to a typical range for the tooth distance to tooth width ratio for the tooth.
Example 99. The computer-implemented method of Example 98, wherein the diagnosis is further determined by identifying the atypical gap in response to the measured tooth distance to tooth width ratio being outside of the typical range.
Example 100. The computer-implemented method of any one of Examples 91 to 99, wherein the server computing device is further configured to identify a facial midline of the patient in the 2D image.
Example 101. The computer-implemented method of Example 100, wherein the server computing device is further configured to rotate the 2D image so that the facial midline is substantially vertical, before determining the segmentation mask.
Example 102. The computer-implemented method of any one of Examples 91 to 101, wherein:
   the segmentation mask further comprises a lip mask corresponding to a shape of the patient's lips,
   the at least one spatial parameter comprises lip symmetry, and
   the dental condition comprises an uneven smile.
Example 103. The computer-implemented method of any one of Examples 91 to 102, further comprising displaying an indication of the dental condition on a display device.
Example 104. The computer-implemented method of any one of Examples 91 to 103, further comprising receiving a treatment recommendation from the server computing device.
Example 105. The computer-implemented method of any one of Examples 91 to 104, wherein the 2D image comprises a photograph or a frame of a video.
Example 106. The computer-implemented method of any one of Examples 91 to 105, wherein the 2D image is obtained from a camera that is part of or is operably coupled to a mobile device.
Example 107. A computer-implemented method for identifying a dental condition from a patient image, the computer-implemented method comprising, by one or more processors:
   accessing a 2D image depicting a patient's teeth;
   determining a segmentation mask for the 2D image, the segmentation mask including a plurality of tooth masks corresponding to a plurality of individual teeth of the patient's teeth;
   measuring at least one spatial parameter using the segmentation mask, wherein the at least one spatial parameter comprises one or more of a shape of an object feature in an intraoral cavity of the patient or a spatial relationship between two or more object features in the intraoral cavity of the patient; and
   identifying a dental condition for the patient's teeth based on the at least one spatial parameter.
Example 108. The computer-implemented method of Example 107, wherein the at least one spatial parameter comprises a central incisor shift ratio, and wherein the dental condition comprises a dental midline shift.
Example 109. The computer-implemented method of Example 108, further comprising:
   identifying a pair of tooth masks of the plurality of tooth masks corresponding to a pair of central incisors of the patient, and
   measuring the central incisor shift ratio using the pair of tooth masks.
Example 110. The computer-implemented method of any one of Examples 107 to 109, wherein the at least one spatial parameter comprises central incisor angulation, and wherein the dental condition comprises an uneven smile.
Example 111. The computer-implemented method of Example 110, further comprising:
   identifying a pair of tooth masks of the plurality of tooth masks corresponding to a pair of central incisors of the patient, and
   measuring the central incisor angulation using the pair of tooth masks.
Example 112. The computer-implemented method of any one of Examples 107 to 111, wherein the at least one spatial parameter comprises a tooth distance to tooth width ratio, and wherein the dental condition comprises an atypical gap in the patient's teeth.
Example 113. The computer-implemented method of Example 112, wherein the atypical gap is due to a missing tooth.
Example 114. The computer-implemented method of Example 112 or 113, further comprising:
   measuring the tooth distance to tooth width ratio for a tooth of the patient, and
   comparing the measured tooth distance to tooth width for the tooth to a typical range for the tooth distance to tooth width ratio for the tooth.
Example 115. The computer-implemented method of Example 114, further comprising identifying the atypical gap in response to the measured tooth distance to tooth width ratio being outside of the typical range.
Example 116. The computer-implemented method of any one of Examples 107 to 115, further comprising identifying a facial midline of the patient in the 2D image.
Example 117. The computer-implemented method of Example 116, further comprising rotating the 2D image so that the facial midline is substantially vertical, before determining the segmentation mask.
Example 118. The computer-implemented method of any one of Examples 107 to 117, wherein:
   the segmentation mask further comprises a lip mask corresponding to a shape of the patient's lips,
   the at least one spatial parameter comprises lip symmetry, and
   the dental condition comprises an uneven smile.
Example 119. The computer-implemented method of any one of Examples 107 to 118, further comprising causing a display of an indication of the dental condition on a display device.
Example 120. The computer-implemented method of Example 119, wherein the display device is remote from the one or more processors.
Example 121. The computer-implemented method of any one of Examples 107 to 120, further comprising generating a treatment recommendation based on the identified dental condition.
Example 122. The computer-implemented method of any one of Examples 107 to 121, wherein the 2D image comprises a photograph or a frame of a video.
Example 123. The computer-implemented method of any one of Examples 107 to 122, wherein the 2D image is obtained from an imaging device that is remote from the one or more processors.
Example 124. The computer-implemented method of Example 123, wherein the imaging device comprises a camera that is part of or is operably coupled to a mobile device.
Example 125. A non-transitory computer-readable storage medium comprising instructions that, when executed by one or more processors of a computing system, cause the computing system to perform operations comprising:
   accessing a 2D image depicting a patient's teeth;
   determining a segmentation mask for the 2D image, the segmentation mask including a plurality of tooth masks corresponding to a plurality of individual teeth of the patient's teeth;
   measuring at least one spatial parameter using the segmentation mask, wherein the at least one spatial parameter comprises one or more of a shape of an object feature in an intraoral cavity of the patient or a spatial relationship between two or more object features in the intraoral cavity of the patient; and
   identifying a dental condition for the patient's teeth based on the at least one spatial parameter.
Example 126. The non-transitory computer-readable storage medium of Example 113, wherein the at least one spatial parameter comprises a central incisor shift ratio, and wherein the dental condition comprises a dental midline shift.
Example 127. The non-transitory computer-readable storage medium of Example 125 or 126, wherein the at least one spatial parameter comprises central incisor angulation, and wherein the dental condition comprises an uneven smile.
Example 128. The non-transitory computer-readable storage medium of any one of Examples 125 to 127, wherein the at least one spatial parameter comprises a tooth distance to tooth width ratio, and wherein the dental condition comprises an atypical gap in the patient's teeth.
Example 129. The non-transitory computer-readable storage medium of any one of Examples 125 to 128, wherein:

the segmentation mask further comprises a lip mask corresponding to a shape of the patient's lips, the at least one spatial parameter comprises lip symmetry, and the dental condition comprises an uneven smile.
Example 130. The non-transitory computer-readable storage medium of any one of Examples 125 to 129, wherein the operations further comprise causing a display of an indication of the dental condition on a display device.
Example 131. The non-transitory computer-readable storage medium of any one of Examples 125 to 130, wherein the operations further comprise generating a treatment recommendation based on the identified dental condition.
Example 132. The non-transitory computer-readable storage medium of any one of Examples 125 to 131, wherein the 2D image comprises a photograph or a frame of a video.
Example 133. The non-transitory computer-readable storage medium of any one of Examples 125 to 132, wherein the 2D image is obtained from a camera that is part of or is operably coupled to a mobile device.
Example 134. A method for treating a patient, the method comprising: receiving or generating the treatment recommendation according to the computer-implemented method of any one of Examples 32, 33, 52, 53, 104, or 121; and administering a treatment to the patient according to the treatment recommendation.
Example 135. A system for identifying a dental condition from a patient image, the system comprising:
   one or more processors; and
   a memory storing instructions that, when executed by the one or more processors, cause the system to perform operations comprising:
      accessing a 2D image depicting a patient's teeth;
      determining a segmentation mask for the 2D image, the segmentation mask including a plurality of tooth masks corresponding to a plurality of individual teeth of the patient's teeth;
      measuring at least one spatial parameter using the segmentation mask, wherein the at least one spatial parameter comprises a spatial relationship between two or more tooth masks of the segmentation mask; and
      identifying a dental condition for the patient's teeth based on the at least one spatial parameter, wherein the dental condition comprises an uneven smile.
Example 136. The system of Example 135, wherein the at least one spatial parameter comprises central incisor angulation.
Example 137. The system of Example 136, wherein the two or more tooth masks comprise a pair of tooth masks corresponding to a pair of central incisors of the patient, and wherein the central incisor angulation is measured using the pair of tooth masks.
Example 138. The system of any one of Examples 135 to 137, wherein:
   the segmentation mask further comprises a lip mask corresponding to a shape of the patient's lips, and
   the at least one spatial parameter comprises lip symmetry.
Example 139. The system of any one of Examples 135 to 138, wherein the operations further comprise identifying a facial midline of the patient in the 2D image.
Example 140. The system of Example 139, wherein the operations further comprise rotating the 2D image so that the facial midline is substantially vertical, before determining the segmentation mask.
Example 141. The system of any one of Examples 135 to 140, wherein the operations further comprise causing a display of an indication of the dental condition on a display device.
Example 142. The system of any one of Examples 135 to 141, wherein the operations further comprise generating a treatment recommendation based on the identified dental condition.
Example 143. The system of any one of Examples 135 to 142, wherein the 2D image comprises a photograph or a frame of a video.
Example 144. The system of any one of Examples 135 to 143, wherein the 2D image is obtained from an imaging device that is remote from the one or more processors, and wherein the imaging device comprises a camera that is part of or is operably coupled to a mobile device.
Example 145. A computer-implemented method for identifying a dental condition from a patient image, the computer-implemented method comprising, by one or more processors: accessing a 2D image depicting a patient's teeth;
   transmitting the 2D image to a server computing device; and
   receiving a diagnosis of a dental condition for the patient's teeth from the server computing device, wherein the server computing device is configured to determine the diagnosis by:
      determining a segmentation mask for the 2D image, the segmentation mask including a plurality of tooth masks corresponding to a plurality of individual teeth of the patient's teeth,
      measuring at least one spatial parameter using the segmentation mask, wherein the at least one spatial parameter comprises a spatial relationship between two or more tooth masks of the segmentation mask, and
      identifying a dental condition for the patient's teeth based on the at least one spatial parameter, wherein the dental condition comprises an uneven smile.
Example 146. The computer-implemented method of Example 145, wherein the at least one spatial parameter comprises central incisor angulation.
Example 147. The computer-implemented method of Example 146, wherein the two or more tooth masks comprise a pair of tooth masks corresponding to a pair of central incisors of the patient, and wherein the central incisor angulation is measured using the pair of tooth masks.
Example 148. The computer-implemented method of any one of Examples 145 to 147, wherein:
   the segmentation mask further comprises a lip mask corresponding to a shape of the patient's lips, and
   the at least one spatial parameter comprises lip symmetry.
Example 149. The computer-implemented method of any one of Examples 145 to 148, further comprising displaying of an indication of the dental condition on a display device.
Example 150. The computer-implemented method of any one of Examples 145 to 149, further comprising receiving a treatment recommendation from the server computing device.
Example 151. A method for treating a patient, the method comprising:
   receiving the treatment recommendation according to the computer-implemented method of Example 150; and
   administering a treatment to the patient according to the treatment recommendation.

### CONCLUSION

Although many of the embodiments are described above with respect to systems, devices, and methods for identifying dental conditions, the technology is applicable to other applications and/or other approaches, such as identifying other features of interest related to the intraoral cavity. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-18.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage;

magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for identifying a dental condition from a patient image, the system comprising:
one or more processors; and
a memory storing instructions that, when executed by the one or more processors, cause the system to perform operations comprising:
accessing a 2D image depicting a patient's teeth;
determining a segmentation mask for the 2D image, the segmentation mask including a plurality of tooth masks corresponding to a plurality of individual teeth of the patient's teeth;
measuring at least one spatial parameter using the segmentation mask, wherein the at least one spatial parameter comprises a spatial relationship between two or more tooth masks of the segmentation mask; and
identifying a dental condition for the patient's teeth based on the at least one spatial parameter, wherein the dental condition comprises an uneven smile.

2. The system of claim 1, wherein the at least one spatial parameter comprises central incisor angulation.

3. The system of claim 2, wherein the two or more tooth masks comprise a pair of tooth masks corresponding to a pair of central incisors of the patient, and wherein the central incisor angulation is measured using the pair of tooth masks.

4. The system of claim 1, wherein:
the segmentation mask further comprises a lip mask corresponding to a shape of the patient's lips, and
the at least one spatial parameter comprises lip symmetry.

5. The system of claim 1, wherein the operations further comprise identifying a facial midline of the patient in the 2D image.

6. The system of claim 5, wherein the operations further comprise rotating the 2D image so that the facial midline is substantially vertical, before determining the segmentation mask.

7. The system of claim 1, wherein the operations further comprise causing a display of an indication of the dental condition on a display device.

8. The system of claim 1, wherein the operations further comprise generating a treatment recommendation based on the identified dental condition.

9. The system of claim 1, wherein the 2D image comprises a photograph or a frame of a video.

10. The system of claim 1, wherein the 2D image is obtained from an imaging device that is remote from the one or more processors, and wherein the imaging device comprises a camera that is part of or is operably coupled to a mobile device.

11. A computer-implemented method for identifying a dental condition from a patient image, the computer-implemented method comprising, by one or more processors:
accessing a 2D image depicting a patient's teeth;
transmitting the 2D image to a server computing device; and
receiving a diagnosis of a dental condition for the patient's teeth from the server computing device, wherein the server computing device is configured to determine the diagnosis by:
determining a segmentation mask for the 2D image, the segmentation mask including a plurality of tooth masks corresponding to a plurality of individual teeth of the patient's teeth,
measuring at least one spatial parameter using the segmentation mask, wherein the at least one spatial parameter comprises a spatial relationship between two or more tooth masks of the segmentation mask, and
identifying a dental condition for the patient's teeth based on the at least one spatial parameter, wherein the dental condition comprises an uneven smile.

12. The computer-implemented method of claim 11, wherein the at least one spatial parameter comprises central incisor angulation.

13. The computer-implemented method of claim 12, wherein the two or more tooth masks comprise a pair of tooth masks corresponding to a pair of central incisors of the patient, and wherein the central incisor angulation is measured using the pair of tooth masks.

14. The computer-implemented method of claim 11, wherein:
the segmentation mask further comprises a lip mask corresponding to a shape of the patient's lips, and
the at least one spatial parameter comprises lip symmetry.

15. The computer-implemented method of claim 11, further comprising displaying of an indication of the dental condition on a display device.

16. The computer-implemented method of claim 11, further comprising receiving a treatment recommendation from the server computing device.

17. A method for treating a patient, the method comprising:
receiving the treatment recommendation according to the computer-implemented method of claim 16; and
administering a treatment to the patient according to the treatment recommendation.

18. A computer-implemented method for identifying a dental condition from a patient image, the computer-implemented method comprising, by one or more processors:
accessing a 2D image depicting a patient's teeth;
transmitting the 2D image to a server computing device; and
receiving a diagnosis of a dental condition for the patient's teeth from the server computing device, wherein the server computing device is configured to determine the diagnosis by:
determining a segmentation mask for the 2D image, the segmentation mask including a plurality of tooth masks corresponding to a plurality of individual teeth of the patient's teeth,
measuring at least one spatial parameter using the segmentation mask, wherein the at least one spatial parameter comprises one or more of a shape of an object feature in an intraoral cavity of the patient or a spatial relationship between two or more object features in the intraoral cavity of the patient, and
identifying a dental condition for the patient's teeth based on the at least one spatial parameter.

19. The computer-implemented method of claim 18, wherein the at least one spatial parameter comprises central incisor angulation, and wherein the dental condition comprises an uneven smile.

20. The computer-implemented method of claim 18, wherein the at least one spatial parameter comprises a tooth distance to tooth width ratio, and wherein the dental condition comprises an atypical gap in the patient's teeth.
